(19) United States
(12) Patent Application Publication
(10) Pub. No.: US 2026/0012377 A1
(43) Pub. Date: Jan. 8, 2026

(54) SIGNALING FOR DICTIONARY LEARNING TECHNIQUES FOR CHANNEL ESTIMATION

(71) Applicant: QUALCOMM INCORPORATED, San Diego, CA (US)

(72) Inventors: Hamed Pezeshki, San Diego, CA (US); Arash Behboodi, Amsterdam (NL); Mahmoud Taherzadeh Boroujeni, San Diego, CA (US); Tao Luo, San Diego, CA (US); Peter Gaal, San Diego, CA (US); Qiaoyu Li, Beijing (CN); Junyi Li, Greentown, PA (US); Wooseok Nam, San Diego, CA (US)

(21) Appl. No.: 18/872,772

(22) PCT Filed: Jul. 25, 2022
(86) PCT No.: PCT/CN2022/107569

§ 371 Date: Dec. 6, 2024

(51) Int. Cl. H04L 25/02; H04B 7/06

(52) U.S. Cl. CPC H04L 25/024; H04B 7/0626; H04B 7/06952

(57) ABSTRACT

Methods, systems, and devices for wireless communication are described. A user equipment (UE) may generate one or more channel estimates for a plurality of channels between the UE and a network entity using a sparse recovery technique. The one or more channel estimates may be based on one or more measurements using a set of directional beams. The UE may compute a dictionary associated with a sparse channel representation of a channel between the UE and the network entity based on a learning procedure using the one or more channel estimates. The UE may transmit a message comprising an indication of the dictionary to the network entity. In some examples, the network entity may compute the dictionary associated with a sparse channel representation of a channel between the UE and the network entity, and the network entity may transmit a message comprising an indication of the dictionary to the UE.

### CROSS REFERENCE

The present application is a 371 national stage filing of International PCT Application No. PCT/CN2022/107569 by Pezeshki et al. entitled “SIGNALING FOR DICTIONARY LEARNING TECHNIQUES FOR CHANNEL ESTIMATION,” filed Jul. 25, 2022, which is assigned to the assignee hereof, and which is expressly incorporated by reference in its entirety herein.

### FIELD OF TECHNOLOGY

The following relates to wireless communication, including signaling for dictionary learning techniques for channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE and a network entity, or some other combination of wireless devices may perform beam selection techniques to select one or more beams to use for communications between the devices. Techniques for performing such beam selection procedures may be improved.

### SUMMARY

The described techniques relate to improved methods, systems, devices, and apparatuses that support signaling for dictionary learning techniques for channel estimation. Generally, a user equipment (UE), a network entity, or both may perform a dictionary learning procedure to determine channel information. The UE, the network entity, or both may then use a learned dictionary to determine a channel, where the channel may be leveraged to select a customized beam (e.g., one or more dynamic beam directions that may be different from a set of pre-determined beams corresponding to a codebook) for communications between the devices. For example, the UE may log raw channel estimates as the UE moves around a cell to use as training samples for the dictionary. In some cases, the UE may satisfy a threshold of training samples to determine a sparsifying dictionary, and upon learning the dictionary, the UE may report the sparsifying dictionary to the network entity. In one example, the network entity may transmit the sparsifying dictionary to similar UEs (e.g., UEs having a same antenna configuration, UEs associated with a same manufacturer, UEs being a same model, UEs 115 of a same type). The UEs may use the sparsifying dictionary for communications in the cell, for example, when determining one or beams for communicating with other devices (e.g., other UEs, a network node, or the like).

Additionally, or alternatively, the UE, or multiple similar UEs, may transmit raw channel estimates to the network entity. The network entity may categorize the raw channel estimates from one UE or from multiple similar UEs and determine a sparsifying dictionary for each UE and/or for each group of similar UEs. In such cases, the network entity may determine a different sparsifying dictionary for each group of similar UEs. The network entity may transmit an indication of the sparsifying dictionaries to respective UEs. Upon determining and/or receiving a sparsifying dictionary, a UE may transmit raw channel estimates to the network entity, where the raw channel estimates may be sparse channel representations. The UE, the network entity, or both may use the sparsifying dictionary and the raw channel estimates to determine the raw channel, and in some cases, the UE, the network entity, or both may perform beam management to select one or more optimal beams between the UE and the network entity based on the raw channel estimate.

A method for wireless communication at a UE is described. The method may include generating one or more channel estimates for a set of multiple channels between the UE and a network entity using a sparse recovery technique, where the one or more channel estimates are based on one or more measurements using a set of directional beams, computing a dictionary associated with a sparse channel representation of a channel between the UE and the network entity based on a learning procedure using the one or more channel estimates, and transmitting a message including an indication of the dictionary to the network entity.

An apparatus for wireless communication at a UE is described. The apparatus may include a processor, memory coupled with the processor, and instructions stored in the memory. The instructions may be executable by the processor to cause the apparatus to generate one or more channel estimates for a set of multiple channels between the UE and a network entity using a sparse recovery technique, where the one or more channel estimates are based on one or more measurements using a set of directional beams, compute a dictionary associated with a sparse channel representation of a channel between the UE and the network entity based on a learning procedure using the one or more channel estimates, and transmit a message including an indication of the dictionary to the network entity.

Another apparatus for wireless communication at a UE is described. The apparatus may include means for generating one or more channel estimates for a set of multiple channels between the UE and a network entity using a sparse recovery technique, where the one or more channel estimates are based on one or more measurements using a set of directional beams, means for computing a dictionary associated with a sparse channel representation of a channel between the UE and the network entity based on a learning procedure using the one or more channel estimates, and means for transmitting a message including an indication of the dictionary to the network entity.

A non-transitory computer-readable medium storing code for wireless communication at a UE is described. The code may include instructions executable by a processor to generate one or more channel estimates for a set of multiple channels between the UE and a network entity using a sparse recovery technique, where the one or more channel estimates are based on one or more measurements using a set of directional beams, compute a dictionary associated with a sparse channel representation of a channel between the UE and the network entity based on a learning procedure using the one or more channel estimates, and transmit a message including an indication of the dictionary to the network entity.

Some examples of the method, apparatuses, and non-transitory computer-readable medium described herein may further include operations, features, means, or instructions for transmitting a feedback message indicating the sparse channel representation of the channel between the UE and the network entity, the feedback message including a set of indices of non-zero elements in the sparse channel representation and a quantized set of the non-zero elements in the sparse channel representation.

Some examples of the method, apparatuses, and non-transitory computer-readable medium described herein may further include operations, features, means, or instructions for receiving a signal indicating a configuration to transmit the sparse channel representation for a number of dominant taps of the channel, where transmitting the feedback message may be based on the configuration.

In some examples of the method, apparatuses, and non-transitory computer-readable medium described herein, transmitting the feedback message may include operations, features, means, or instructions for transmitting, with the feedback message, an identifier of the dictionary associated with the sparse channel representation.

Some examples of the method, apparatuses, and non-transitory computer-readable medium described herein may further include operations, features, means, or instructions for receiving a signal indicating a configuration of a threshold number of training samples to obtain prior to computing the dictionary, where transmitting the message may be based on the threshold number of training samples being satisfied.

Some examples of the method, apparatuses, and non-transitory computer-readable medium described herein may further include operations, features, means, or instructions for obtaining a number of training samples that at least satisfies the threshold number of training samples, where the UE computes the dictionary based on the number of training samples satisfying the threshold.

Some examples of the method, apparatuses, and non-transitory computer-readable medium described herein may further include operations, features, means, or instructions for obtaining respective training samples at one or more locations of the UE, at one or more times of day, or a combination thereof, where the one or more channel estimates may be based on the respective training samples.

Some examples of the method, apparatuses, and non-transitory computer-readable medium described herein may further include operations, features, means, or instructions for receiving a signal indicating a configuration of a set of parameters for computing the dictionary, the set of parameters including criteria for stopping the learning procedure, a number of atoms to be included in the dictionary, or a combination thereof, where the dictionary may be computed in accordance with the set of parameters.

Some examples of the method, apparatuses, and non-transitory computer-readable medium described herein may further include operations, features, means, or instructions for computing an updated dictionary based on a change in one or more conditions for which the dictionary may be dependent, where the indication of the dictionary includes an indication of the updated dictionary.

In some examples of the method, apparatuses, and non-transitory computer-readable medium described herein, the one or more conditions include a location of the UE relative to the network entity, a time of day, or a combination thereof.

In some examples of the method, apparatuses, and non-transitory computer-readable medium described herein, generating the one or more channel estimates using the sparse recovery technique may include operations, features, means, or instructions for generating the one or more channel estimates using an orthogonal matching pursuit (OMP) algorithm.

A method for wireless communication at a network entity is described. The method may include receiving a message including an indication of a dictionary associated with a sparse channel representation of a channel between a UE and the network entity, performing a beam management procedure for selecting one or more directional beams based on the dictionary, and communicating with the UE using the one or more directional beams.

An apparatus for wireless communication at a network entity is described. The apparatus may include a processor, memory coupled with the processor, and instructions stored in the memory. The instructions may be executable by the processor to cause the apparatus to receive a message including an indication of a dictionary associated with a sparse channel representation of a channel between a UE and the network entity, perform a beam management procedure for selecting one or more directional beams based on the dictionary, and communicate with the UE using the one or more directional beams.

Another apparatus for wireless communication at a network entity is described. The apparatus may include means for receiving a message including an indication of a dictionary associated with a sparse channel representation of a channel between a UE and the network entity, means for performing a beam management procedure for selecting one or more directional beams based on the dictionary, and means for communicating with the UE using the one or more directional beams.

A non-transitory computer-readable medium storing code for wireless communication at a network entity is described. The code may include instructions executable by a processor to receive a message including an indication of a dictionary associated with a sparse channel representation of a channel between a UE and the network entity, perform a beam management procedure for selecting one or more directional beams based on the dictionary, and communicate with the UE using the one or more directional beams.

Some examples of the method, apparatuses, and non-transitory computer-readable medium described herein may further include operations, features, means, or instructions for transmitting, to one or more other UEs, one or more messages each including an indication of the dictionary, the one or more other UEs having a same antenna configuration as the UE, being associated with a same manufacturer as the UE, being a same model as the UE, being a same type as the UE, or a combination thereof.

Some examples of the method, apparatuses, and non-transitory computer-readable medium described herein may further include operations, features, means, or instructions for receiving a feedback message indicating the sparse channel representation of the channel between the UE and the network entity, the feedback message including a set of indices of non-zero elements in the sparse channel representation and a quantized set of the non-zero elements in the sparse channel representation.

Some examples of the method, apparatuses, and non-transitory computer-readable medium described herein may further include operations, features, means, or instructions for transmitting a signal indicating a configuration for transmitting the sparse channel representation for a number of dominant taps of the channel, where receiving the feedback message may be based on the configuration.

In some examples of the method, apparatuses, and non-transitory computer-readable medium described herein, receiving the feedback message may include operations, features, means, or instructions for receiving, with the feedback message, an identifier of the dictionary associated with the sparse channel representation.

Some examples of the method, apparatuses, and non-transitory computer-readable medium described herein may further include operations, features, means, or instructions for estimating the channel between the UE and the network entity using the dictionary and the sparse channel representation, where performing the beam management procedure may be based on estimating the channel.

Some examples of the method, apparatuses, and non-transitory computer-readable medium described herein may further include operations, features, means, or instructions for transmitting a signal indicating a configuration of a threshold number of training samples for computing the dictionary, where receiving the message may be based on the threshold number of training samples being satisfied.

Some examples of the method, apparatuses, and non-transitory computer-readable medium described herein may further include operations, features, means, or instructions for transmitting a signal indicating a configuration of a set of parameters for computing the dictionary, the set of parameters including criteria for stopping a learning procedure, a number of atoms to be included in the dictionary, or a combination thereof, where the dictionary may be based on the set of parameters.

In some examples of the method, apparatuses, and non-transitory computer-readable medium described herein, the indication of the dictionary includes an indication of an updated dictionary that may have been updated based on a change in one or more conditions for which the dictionary may be dependent.

In some examples of the method, apparatuses, and non-transitory computer-readable medium described herein, the one or more conditions include a location of the UE relative to the network entity, a time of day, or a combination thereof.

A method for wireless communication at a UE is described. The method may include generating one or more channel estimates for a set of multiple channels between the UE and a network entity using a sparse recovery technique, where the one or more channel estimates are based on one or more measurements using a set of directional beams, transmitting a signal indicating the one or more channel estimates to the network entity, and receiving a message including an indication of a dictionary associated with a sparse channel representation of a channel between the UE and the network entity, the dictionary being based on the one or more channel estimates.

An apparatus for wireless communication at a UE is described. The apparatus may include a processor, memory coupled with the processor, and instructions stored in the memory. The instructions may be executable by the processor to cause the apparatus to generate one or more channel estimates for a set of multiple channels between the UE and a network entity using a sparse recovery technique, where the one or more channel estimates are based on one or more measurements using a set of directional beams, transmit a signal indicating the one or more channel estimates to the network entity, and receive a message including an indication of a dictionary associated with a sparse channel representation of a channel between the UE and the network entity, the dictionary being based on the one or more channel estimates.

Another apparatus for wireless communication at a UE is described. The apparatus may include means for generating one or more channel estimates for a set of multiple channels between the UE and a network entity using a sparse recovery technique, where the one or more channel estimates are based on one or more measurements using a set of directional beams, means for transmitting a signal indicating the one or more channel estimates to the network entity, and means for receiving a message including an indication of a dictionary associated with a sparse channel representation of a channel between the UE and the network entity, the dictionary being based on the one or more channel estimates.

A non-transitory computer-readable medium storing code for wireless communication at a UE is described. The code may include instructions executable by a processor to generate one or more channel estimates for a set of multiple channels between the UE and a network entity using a sparse recovery technique, where the one or more channel estimates are based on one or more measurements using a set of directional beams, transmit a signal indicating the one or more channel estimates to the network entity, and receive a message including an indication of a dictionary associated with a sparse channel representation of a channel between the UE and the network entity, the dictionary being based on the one or more channel estimates.

Some examples of the method, apparatuses, and non-transitory computer-readable medium described herein may further include operations, features, means, or instructions for transmitting, after receiving the dictionary, a feedback message indicating the sparse channel representation of the channel between the UE and the network entity, the feedback message including a set of indices of non-zero elements in the sparse channel representation and a quantized set of the non-zero elements in the sparse channel representation.

Some examples of the method, apparatuses, and non-transitory computer-readable medium described herein may further include operations, features, means, or instructions for receiving a signal indicating a configuration to transmit the sparse channel representation for a number of dominant taps of the channel, where transmitting the feedback message may be based on the configuration.

In some examples of the method, apparatuses, and non-transitory computer-readable medium described herein, transmitting the feedback message may include operations, features, means, or instructions for transmitting, with the feedback message, an identifier of the dictionary associated with the sparse channel representation.

Some examples of the method, apparatuses, and non-transitory computer-readable medium described herein may further include operations, features, means, or instructions for receiving, in the message, an indication of a set of one or more characteristics associated with a set of UEs for which the dictionary may be applicable.

Some examples of the method, apparatuses, and non-transitory computer-readable medium described herein may further include operations, features, means, or instructions for receiving, in the message, an indication of set of one or more conditions for which the dictionary may be applicable, the set of one or more conditions including a geographic location, a time of day, a zone, or a combination thereof.

Some examples of the method, apparatuses, and non-transitory computer-readable medium described herein may further include operations, features, means, or instructions for performing an operation to compress the one or more channel estimates, where the signal indicating the one or more channel estimates includes the compressed one or more channel estimates.

Some examples of the method, apparatuses, and non-transitory computer-readable medium described herein may further include operations, features, means, or instructions for performing the operation to compress the one or more channel estimates may be based on an auto-encoder, one or more compression schemes, or a combination thereof.

Some examples of the method, apparatuses, and non-transitory computer-readable medium described herein may further include operations, features, means, or instructions for receiving a signal indicating a configuration to transmit the indication of the one or more channel estimates for a number of dominant taps of the channel, where transmitting the signal may be based on the configuration.

Some examples of the method, apparatuses, and non-transitory computer-readable medium described herein may further include operations, features, means, or instructions for receiving a second message including an indication of a second dictionary associated with a second channel between the UE and the network entity based on a change in one or more conditions for which the dictionary may be dependent.

In some examples of the method, apparatuses, and non-transitory computer-readable medium described herein, the one or more conditions include a location of the UE relative to the network entity, a time of day, or a combination thereof.

Some examples of the method, apparatuses, and non-transitory computer-readable medium described herein may further include operations, features, means, or instructions for obtaining respective training samples at one or more locations of the UE, at one or more times of day, or a combination thereof, where the one or more channel estimates may be based on the respective training samples.

In some examples of the method, apparatuses, and non-transitory computer-readable medium described herein, generating the one or more channel estimates using the sparse recovery technique may include operations, features, means, or instructions for generating the one or more channel estimates using an orthogonal matching pursuit (OMP) algorithm.

In some examples of the method, apparatuses, and non-transitory computer-readable medium described herein, the message includes a radio resource control message.

A method for wireless communication at a network entity is described. The method may include receiving, from each UE of a set of one or more UEs, respective signals indicating one or more channel estimates for a set of multiple channels between each UE and the network entity, computing a dictionary associated with a sparse channel representation of a channel between the UE and the network entity based on a learning procedure using the one or more channel estimates, and transmitting a message including an indication of the dictionary to a UE.

An apparatus for wireless communication at a network entity is described. The apparatus may include a processor, memory coupled with the processor, and instructions stored in the memory. The instructions may be executable by the processor to cause the apparatus to receive, from each UE of a set of one or more UEs, respective signals indicating one or more channel estimates for a set of multiple channels between each UE and the network entity, compute a dictionary associated with a sparse channel representation of a channel between the UE and the network entity based on a learning procedure using the one or more channel estimates, and transmit a message including an indication of the dictionary to a UE.

Another apparatus for wireless communication at a network entity is described. The apparatus may include means for receiving, from each UE of a set of one or more UEs, respective signals indicating one or more channel estimates for a set of multiple channels between each UE and the network entity, means for computing a dictionary associated with a sparse channel representation of a channel between the UE and the network entity based on a learning procedure using the one or more channel estimates, and means for transmitting a message including an indication of the dictionary to a UE.

A non-transitory computer-readable medium storing code for wireless communication at a network entity is described. The code may include instructions executable by a processor to receive, from each UE of a set of one or more UEs, respective signals indicating one or more channel estimates for a set of multiple channels between each UE and the network entity, compute a dictionary associated with a sparse channel representation of a channel between the UE and the network entity based on a learning procedure using the one or more channel estimates, and transmit a message including an indication of the dictionary to a UE.

Some examples of the method, apparatuses, and non-transitory computer-readable medium described herein may further include operations, features, means, or instructions for receiving, after transmitting the dictionary, a feedback message indicating the sparse channel representation of the channel between the UE and the network entity, the feedback message including a set of indices of non-zero elements in the sparse channel representation and a quantized set of the non-zero elements in the sparse channel representation.

Some examples of the method, apparatuses, and non-transitory computer-readable medium described herein may further include operations, features, means, or instructions for estimating the channel between the UE and the network entity using the dictionary and the sparse channel representation and performing a beam management procedure for selecting one or more directional beams based on estimating the channel.

Some examples of the method, apparatuses, and non-transitory computer-readable medium described herein may further include operations, features, means, or instructions for transmitting a signal indicating a configuration for transmitting the sparse channel representation for a number of dominant taps of the channel, where receiving the feedback message may be based on the configuration.

In some examples of the method, apparatuses, and non-transitory computer-readable medium described herein, transmitting the feedback message may include operations, features, means, or instructions for receiving, with the feedback message, an identifier of the dictionary associated with the sparse channel representation.

Some examples of the method, apparatuses, and non-transitory computer-readable medium described herein may further include operations, features, means, or instructions for transmitting, in the message, an indication of a set of one or more characteristics associated with a set of UEs for which the dictionary may be applicable.

Some examples of the method, apparatuses, and non-transitory computer-readable medium described herein may further include operations, features, means, or instructions for transmitting, in the message, an indication of set of one or more conditions for which the dictionary may be applicable, the set of one or more conditions including a geographic location, a time of day, a zone, or a combination thereof.

Some examples of the method, apparatuses, and non-transitory computer-readable medium described herein may further include operations, features, means, or instructions for transmitting a signal indicating a configuration for transmitting the one or more channel estimates for a number of dominant taps of the channel, where the network entity receives the one or more channel estimates for the number of dominant taps.

Some examples of the method, apparatuses, and non-transitory computer-readable medium described herein may further include operations, features, means, or instructions for transmitting a second message including an indication of a second dictionary associated with a second channel between the UE and the network entity based on a change in one or more conditions for which the dictionary may be dependent.

In some examples of the method, apparatuses, and non-transitory computer-readable medium described herein, the one or more conditions include a location of the UE relative to the network entity, a time of day, or a combination thereof.

In some examples of the method, apparatuses, and non-transitory computer-readable medium described herein, the respective signals indicating the one or more channel estimates includes compressed versions of the one or more channel estimates.

Some examples of the method, apparatuses, and non-transitory computer-readable medium described herein may further include operations, features, means, or instructions for computing the dictionary may be based on each UE of the set of one or more UEs having a same antenna configuration, being associated with a same manufacturer, being a same model, being a same type, or a combination thereof.

In some examples of the method, apparatuses, and non-transitory computer-readable medium described herein, the message includes a radio resource control message.

### BRIEF DESCRIPTION OF THE DRAWINGS

FIGS. 1 through 3 illustrate examples of wireless communications systems that support signaling for dictionary learning techniques for channel estimation in accordance with one or more aspects of the present disclosure.

FIGS. 4 and 5 illustrate examples of process flows in a system that support signaling for dictionary learning techniques for channel estimation in accordance with one or more aspects of the present disclosure.

FIGS. 6 and 7 show block diagrams of devices that support signaling for dictionary learning techniques for channel estimation in accordance with one or more aspects of the present disclosure.

FIG. 8 shows a block diagram of a communications manager that supports signaling for dictionary learning techniques for channel estimation in accordance with one or more aspects of the present disclosure.

FIG. 9 shows a diagram of a system including a device that supports signaling for dictionary learning techniques for channel estimation in accordance with one or more aspects of the present disclosure.

FIGS. 10 and 11 show block diagrams of devices that support signaling for dictionary learning techniques for channel estimation in accordance with one or more aspects of the present disclosure.

FIG. 12 shows a block diagram of a communications manager that supports signaling for dictionary learning techniques for channel estimation in accordance with one or more aspects of the present disclosure.

FIG. 13 shows a diagram of a system including a device that supports signaling for dictionary learning techniques for channel estimation in accordance with one or more aspects of the present disclosure.

FIGS. 14 through 19 show flowcharts illustrating methods that support signaling for dictionary learning techniques for channel estimation in accordance with one or more aspects of the present disclosure.

### DETAILED DESCRIPTION

Some wireless communications systems (e.g., millimeter wave (mmW) wireless communication systems) may support beam selection techniques that allow for a user equipment (UE) and a network entity to communicate by selecting one or more optimal beams for communications between the network devices. In some cases, selection of the beam may be based on a set of directional beams established by a pre-defined codebook. For example, a UE or a network entity may perform a raw channel estimation (e.g., using beamformed channel measurements) to support digital beamforming. The raw channel may refer to the communications channel between the network entity and the UE in the absence of beamforming, and channel information associated with the raw channel may be applicable to signaling between the network entity and the UE, such as beamformed signaling using a beam pair link. The beam pair link may include a predefined transmit beam and predefined receive beams based on the predefined codebook configured by the network. However, the pre-defined codebook, may constrain the UE and the network entity to a relatively limited number of directional beams, which may result in inefficiencies. Additionally, when performing the raw channel estimation, the channel estimation may, in some cases, be based on a total number of possible beamformed channel measurements, which may be based on each beam direction available at the network entity and the UE. However, measuring each possible transmit beam and receive beam combination may result in a relatively large overhead (e.g., due to a quantity of measurements performed). In such cases, the overhead used for channel estimation may consume a relatively large amount of resources and may result in increased inefficiency.

Techniques are described herein for enabling a UE, a network entity, or both to use dictionary learning to determine channel information, which may then be used to select a customized beam for communications. In such cases, using dictionary learning techniques for raw channel estimation may result in the identification of a relatively greater number of beam directions in comparison to using the pre-defined codebook. Additionally, dictionary learning techniques allow for performing raw channel estimation without having to perform beamformed channel measurements associated with each beam direction. Dictionary learning may include reconstructing a channel by estimating information from raw channels using a sparsifying dictionary derived from raw channel data. For example, the UE may log raw channel estimates as the UE moves around a cell to use as training samples for the dictionary. In some cases, the UE may satisfy a threshold of training samples to determine (e.g., estimate, infer) the sparsifying dictionary, and upon learning a sparsifying dictionary, the UE may report the sparsifying dictionary to the network entity. In one example, the network entity may transmit (e.g., relay) the sparsifying dictionary to similar UEs (e.g., UEs with the same antenna configuration, UEs of the same make, model, or other similar capabilities or characteristics), such that the UEs may use the sparsifying dictionary for communications in the cell.

Alternatively, the UE, or multiple similar UEs, may transmit raw channel estimates to the network entity. The network entity may categorize the raw channel estimates from one UE or from multiple similar UEs and determine (e.g., estimate, infer) a sparsifying dictionary for each UE and/or for each group of similar UEs. In such cases, the network entity may determine a different sparsifying dictionary for each group of similar UEs. The network entity may transmit an indication of the sparsifying dictionaries to respective UEs.

Upon determining and/or receiving a sparsifying dictionary, a UE may transmit raw channel estimates to the network entity, where the raw channel estimates may be sparse channel representations. The UE, the network entity, or both may use the sparsifying dictionary and the raw channel estimates to determine the raw channel (e.g., construct the raw channel), and in some cases, the UE, the network entity, or both may perform beam management to select one or more optimal beams between the UE and the network entity based on the raw channel estimate. For example, the UE, the network entity, or both may perform a grid search over oversampled codebook beams to find an optimal beam pair based on the determined raw channel.

Particular aspects of the subject matter described herein may be implemented to realize one or more advantages. The described techniques of using dictionary learning to perform raw channel estimation may result in selecting a customized beamforming direction that may not be included in the set of beams from the pre-defined codebook). The described techniques may support improved performance, increased efficiency, and decreased overhead for wireless communications. As such, supported techniques may include improved network operations and, in some examples, may promote network efficiencies, among other benefits.

Aspects of the disclosure are initially described in the context of wireless communications systems. Aspects of the disclosure are illustrated by and described with reference to process flows. Aspects of the disclosure are further illustrated by and described with reference to apparatus diagrams, system diagrams, and flowcharts that relate to signaling for dictionary learning techniques for channel estimation.

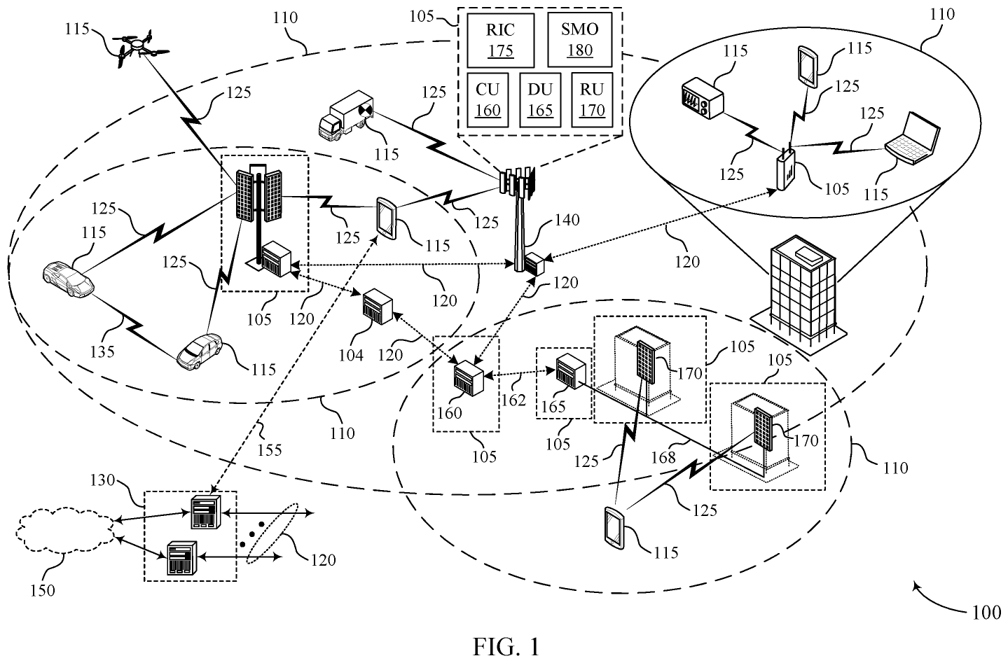

FIG. 1 illustrates an example of a wireless communications system 100 that supports signaling for dictionary learning techniques for channel estimation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support signaling for dictionary learning techniques for channel estimation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, wireless communication between devices, such as between a network entity 105 and a UE 115, may be performed using multiple beam directions, and a device may use analog beam forming or digital beam forming to select an optimal beam for communication. In analog beamforming, a beam is controlled by adjusting analog phase shifters along a radio frequency path. As such, there may be phase shifter for each antenna element and a common analog to digital-to-analog converter (ADC). In digital beamforming, phases and amplitude are digitally controlled, and there may be an ADC per antenna element. In some examples, the UE 115 may utilize beamformed channel measurements (e.g., determined during a beam management procedure) to estimate the channel. For example, a UE 115 or a network entity 105 may perform a raw channel estimation to support digital beamforming. The raw channel may refer to the communications channel between the network entity 105 and the UE 115 in the absence of beamforming. In raw channel estimation, the device may estimate the channel based on a total number of possible beamformed channel measurements, which may be based on total number of beams available at the network entity 105 and the UE 115 (e.g., which may also be based on a total number of available antenna ports at the network entity 105 and the UE 115).

In some cases, the channel matrix may have two dimensions, where a first dimension may correspond to a number of beams available at the network entity 105 and a second dimension may correspond to a number of beams available at the UE 115. For example, the first dimension of the channel matrix may be equal to the total quantity of antenna ports at the network entity 105, and the second dimension of the channel matrix may be equal to the total quantity of antenna ports at the UE 115 (e.g., if the UE 115 has 8 antenna ports and the network entity has 64 antenna ports, the channel matrix may be an 8×64 and may include 512 elements (e.g., a total number of possible beamformed channel measurements)). As such, when performing the raw channel estimation, the channel estimation may in some cases be based on the total number of possible beamformed channel measurements, which may be based on each beam direction available at the network entity 105 and the UE 115. However, measuring each possible transmit beam and receive beam combination may result in a relatively large overhead (e.g., due to a quantity of measurements performed). In such cases, the overhead used for channel estimation may consume a relatively large amount of resources and may result in increased inefficiency.

Wireless communications system 100 may support techniques for performing a raw channel estimation (e.g., estimating an underlying raw channel, or a channel that is independent of which particular beams are used for communication) using a relatively smaller number of beamformed measurements, for example, based on a sparsity of mmW channels. Raw channel estimation may include estimating a channel matrix corresponding to the raw channel, where a compressed representation (e.g., a sparse representation) of the channel matrix may also be derived from the raw channel. The device may utilize a sparse recovery algorithm (e.g., orthogonal matching pursuit (OMP) or any other compressed sensing technique) to determine the sparse representation and to reconstruct the underlying raw channel. For example, the channel between the UE 115 and the network entity 105 may be sparse in the angular domain such that there may be a few dominant paths between the UE 115 and the network entity 105. Accordingly, the sparsity of the channel may be leveraged to perform channel estimation. OMP algorithms may be associated with an iterative algorithm for determining an optimal beam direction based on a quantized set of significant taps. Dictionary learning may include reconstructing a channel by estimating information from raw channels using a sparsifying dictionary derived from raw channel data. The sparsifying dictionary may be made up of atoms, which are elements that indicate channel information. In some examples, when determining the sparse representation, the device may generate a quantized sparse channel representation to determine significant taps (e.g., dominant taps) in the channel. The dominant taps may be associated with significant beam indices for channel estimation.

In some examples, the device may generate the quantized sparse channel representation by dividing an angular space at the UE 115 and the network entity 105 into angular grids, where each angular grid is associated with a number of antenna ports and with an angular range (e.g., the beam direction). In some cases, the UE 115 may determine the angular space to use the OMP algorithm. The angular range may be a range of azimuth angles, a range of elevation angles, or any combination thereof, and may correspond to an antenna port of a device, where two or more beams associated with the device may have direction that are within the indicated angular range. For example, the grid size may be based on a product of the number of azimuth angles at the UE 115, the number of elevation angles at the UE 115, the number of azimuth angles at the network entity 105, and the number of elevation angles at the network entity 105. Based on the angular grid, the device may determine dominant taps in the channel corresponding to significant (e.g., optimal) beams, and the device may use the dominant taps to estimate (e.g., reconstruct) the raw channel through the OMP algorithm. The OMP algorithm may be an iterative algorithm that may select an optimal beam direction based on a number of dominant taps from a corresponding angular grid, such that the algorithm iterates for every dominant tap. The device may use (e.g., run) the OMP algorithm, which may include iterating per dominant tap and determining the optimal azimuth angle and elevation angle per dominant tap until a criteria (e.g., a threshold) is met or until the device has run the OMP algorithm some number of times. However, in some examples, the device running the OMP algorithm may consume a relatively large amount of resources and may result in reduced efficiency due to multiple iterations.

Additionally, or alternatively, raw channel estimation may also support individual selection (e.g., individual optimization) of transmit beams and receive beams (e.g., may enhance analog or digital beamforming), compared with other techniques which may be limited to using a default codebook of beams (e.g., a discrete Fourier transform (DFT)-based codebook). In some cases, selection of the optimal beam may be based on a set of directional beams established by a pre-defined codebook. For example, channel information associated with the raw channel may be applicable to signaling between the network entity 105 and the UE 115, such as beamformed signaling using a beam pair link. The beam pair link may include a predefined transmit beam and predefined receive beams based on the predefined codebook configured by the wireless network. However, the pre-defined codebook may constrain the UE 115 and the network entity 105 to a relatively limited number of directional beams, which may result in further inefficiencies.

In some cases, the sparse recovery algorithm may utilize a pre-defined sparsifying dictionary by dividing the angular space into a two dimensional (2D) grid, where the pre-defined sparsifying dictionary may be based on a transmitter element response matrix (e.g., a network entity 105 response computed at 2D angular grid points) and a receiver element response matrix and a (e.g., a UE 115 response computed at 2D angular grid points). To reduce the complexity of sparse recovery algorithms, however, network devices may be configured to perform dictionary learning to learn the sparsifying dictionary directly from training data rather than relying on a pre-defined dictionary.

Because the sparsifying dictionary is learned from training data, the network device may not recognize a correspondence between the sparsifying bases and the angular domain. For example, explicit angular information may not be extracted using dictionary learning. Therefore, to implement a dictionary-learned sparsifying dictionary, an oversampled codebook index may be predicted through non-oversampled codebook measurements. For example, the network device may be configured to estimate the underlying raw channel from beamformed measurements using dictionary learning and identify UE 115 and/or network entity 105 beams from the oversampled codebook using the raw channel estimate.

For example, a network device (e.g., a UE 115, a network entity 105, or both) may identify a top number of beam pair measurements, and utilize dictionary learning to estimate a raw channel between then network device and another network device. Then, the network device may perform a grid search over sampled codebook beams to identify an optimal beam pair. Then, then network device may communicate with the other network device using the identified optimal beam pair. In some cases, to perform such a procedure, it may be assumed that the UE 115 knows the antenna element response of the network entity 105 and the UE 115 knows the oversampled network entity codebook. Additionally, or alternatively, it may be assumed that the UE 115 estimates the underlying raw channel and infers the best beam pairs from the oversampled codebook without having to actually measure the oversampled codebook thereby reducing overhead and reducing power consumption. Additionally, or alternatively, it may be assumed that the mapping from raw channel estimates to the indices of the best beams in the oversampled codebook can be done using a trained neural network, machine-learning, or the like.

To learn a sparsifying dictionary for raw channels, the network devices may use the information from the raw channel between the network devices. However, as the devices may not know the raw channels (e.g., the “ground truth” raw channels) in over-the-air deployments, the network devices may instead to rely on the estimated raw channels from sparse recovery techniques such as OMP with predefined dictionaries.

The wireless communications system 100 may support techniques for a UE 115, a network entity 105, or both to use dictionary learning to determine channel information, which may then be used to select a customized beam for communications. In such cases, using dictionary learning techniques for raw channel estimation may result in the identification of a relatively greater number of beam directions in comparison to using the pre-defined codebook. Additionally, dictionary learning techniques allow for performing raw channel estimation without having to perform beamformed channel measurements associated with each beam direction. For example, the UE 115 may log raw channel estimates as the UE 115 moves around a cell to use as training samples for the dictionary. The UE 115 may satisfy a threshold of training samples to determine (e.g., estimate, infer) the sparsifying dictionary, and the UE 115 may report a learned sparsifying dictionary to the network entity 105. In one example, the network entity 105 may transmit the learned sparsifying dictionary to similar UEs 115 (e.g., UEs 115 with the same antenna configuration, of the same make, model, or other capabilities or characteristics that are the same between UEs 115), such that the UEs 115 may use the sparsifying dictionary for communications.

Additionally, or alternatively, the UE 115, or multiple similar UEs 115, may transmit the raw channel estimates to the network entity 105. The network entity 105 may categorize the raw channel estimates from the similar UEs 115 and determine (e.g., estimate, infer) sparsifying dictionaries for different groups of similar UEs 115. The network entity 105 may transmit the sparsifying dictionaries to respective UEs 115. In some cases, upon receiving the dictionary, a UE 115 may transmit raw channel estimates to the network entity 105, such as a sparse channel representation. The UE 115, the network entity 105, or both may use the dictionary and the raw channel estimates to determine the raw channel, and in some cases, the UE 115, the network entity 105, or both may perform beam management to select one or more optimal beams between the UE 115 and the network entity 105. Therefore, using dictionary learning to perform raw channel estimation may result in selecting a customized beamforming direction that may not be included in the set of beams from the pre-defined codebook), which may provide improved performance, increased efficiency, and decreased overhead for wireless communications.

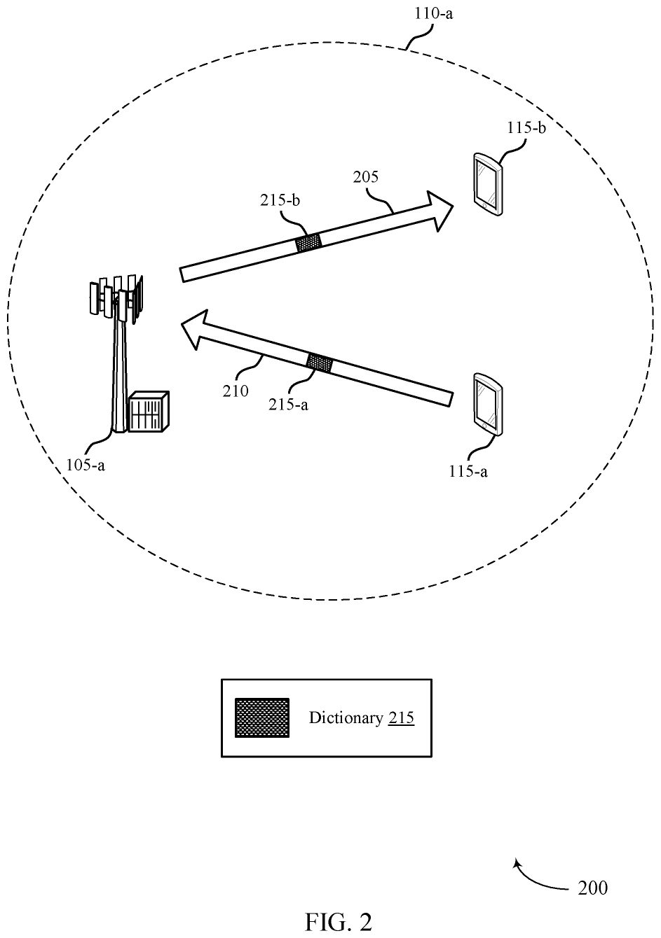

FIG. 2 illustrates an example of a wireless communications system 200 that supports signaling for dictionary learning techniques for channel estimation in accordance with one or more aspects of the present disclosure. In some examples, the wireless communications system 200 may implement aspects of a wireless communications system 100. For example, the wireless communications system 200 may include a UE 115-a, a UE 115-b, and a network entity 105-a which may be examples of a UE 115 and a network entity 105 as described with reference to FIG. 1. In some examples, the network entity 105-a, the UE 115-a, and the UE 115-b may be located in a coverage area 110-a, which may be served by network entity 105-a, or some other network device.

In some examples, network devices (e.g., network entities 105, UEs 115, a nodes) may communicate with one another via directional beams (e.g., channels, communication links such as uplink communication links, downlink communication links, and sidelink communication link). For example, a network entity 105-a may communicate with UE 115-a via uplink and downlink communication links. Similarly, the network entity 105-a may communicate with UE 115-b via uplink and downlink communication links. In some cases, the UE 115-a and the UE 115-b may communicate with one another via sidelink communication links. In one example, the UE 115-a may transmit information (e.g., data signals, control signals) to the network entity 105-a via an uplink communication link 210, and the network entity 105-a may transmit information to the UE 115-b (e.g., a similar UE) via a downlink communication link 205.

In some examples, network devices such as the network entity 105-a and the UE 115-a may undergo a beam management procedure in an effort to identify an optimal beam for communications between the network entity 105-a and the UE 115-a. As described herein, such as with reference to FIG. 1, the UE 115-a, the network entity 105-a, or both may use dictionary learning to determine channel information, which may then be used to select a customized beam for communications such as during beam management procedures. For example, the UE 115-a may log (e.g., obtain, store) raw channel estimates as the UE 115-a moves around a cell (e.g., the coverage area 110-a) to use as training samples (e.g., raw channel estimates, raw channel realizations) for learning a dictionary 215 (e.g., a sparsifying dictionary 215). Accordingly, the UE 115-a may accumulate training samples over time, where each training sample may be a function of time as well as the location of the UE 115 (e.g., within the geographic coverage area 110-a) when the training sample was obtained. For example, the channel information corresponding to the wireless communications system 200 may change over time (e.g., day versus night) or during different scenarios (e.g., relatively high traffic congestion, relatively low traffic congestion), and so the UE 115-a may log different training samples at different times (e.g., day or night), in different scenarios, at different location, or the like, to obtain representative samples (e.g., full samples) of the channel between the UE 115-a and the network entity 105-a.

In some cases, the UE 115-a may be configured to determine the dictionary 215 using one or more of the training samples. In some examples, the UE 115-a may be configured with a threshold number of training samples to obtain (e.g., store) by the UE 115-a prior to learning the sparsifying dictionary 215. In some cases, the UE 115-a may be preconfigured with the threshold number, receive an indication of the threshold number, or autonomously determine the threshold number of training samples. In some cases, the threshold number may be configured by the network entity 105-a and the network entity 105-a may transmit an indication of the threshold number of training samples to the UE 115-a (e.g., via RRC signaling, MAC-CE signaling, downlink control information (DCI) signaling). Accordingly, the UE 115-a may satisfy the threshold of training samples, and use the training samples to learn the sparsifying dictionary 215 (e.g., via one or more trained neural networks, via machine-learning).

Additionally, or alternatively, the UE 115-a may be configured with (e.g., preconfigured with, receive an indication of, or autonomously determine) a set of parameters associated with computing the dictionary 215. For example, the network entity 105-a may transmit a signal indicating a configuration of a set of one or more parameters for computing the dictionary 215. The set of parameters may include stopping criteria, a number of atoms (e.g., information elements) to be included in the dictionary 215, an indication of the neural network, or the like. The stopping criteria may indicate a conclusion of a dictionary learning phase performed by the UE 115-a. For instance, the stopping criteria may be a mean squared error (MSE) between training and validation sets, where an MSE threshold may be configured by the network entity 105-a.

Accordingly, upon satisfying the training sample threshold, the UE 115-a may use the training samples to generate raw channel estimates using a sparse recovery technique (e.g., OMP algorithm), and the UE 115-a may compute (e.g., learn) the dictionary 215, where the UE 115-a may stop the learning procedure upon meeting the stopping criteria. The UE 115-a may report the dictionary 215-a to the network entity 105-a via uplink communication link 210, and in some cases, may report the dictionary 215 to one or more other UEs 115, such as UE 115-b. In some examples, the learned sparsifying dictionary 215 may be applicable for devices of the same type (e.g., similar devices). Similar devices may refer to devices that share the same antenna configuration, devices of the same make, model, or the like. Accordingly, the network entity 105-a and/or UE 115-a may transmit the dictionary 215-b to the UE 115-b via downlink communication link 205, in the case that UE 115-b is a similar device as UE 115-a. Therefore, in some cases, only one device may need to perform dictionary learning to obtain the learned sparsifying dictionary 215 that may be shared across a set of similar devices.

The network entity 105-a and the UE 115-a may use the learned sparsifying dictionary 215 to determine an optimal beam pair between the network entity 105-a and the UE 115-a (e.g., by leveraging a raw channel estimate derived using compressed sensing and/or machine learning algorithms). Similarly, the network entity 105-a and the UE 115-b may use the learned sparsifying dictionary 215 to determine an optimal beam pair between the network entity 105-a and the UE 115-b. For example, during an inference phase, the UE 115-a may use the learned dictionary 215 to estimate the underlying raw channel. In some examples, the network entity 105-a may transmit a signal indicating a configuration for the UE 115-a to transmit the sparse channel representation of dominant taps in the channel(s). Accordingly, the UE 115-a may transmit the indices of non-zero elements in the sparse channel representation along with a quantized version of the non-zero elements, which considerably reduces the overhead. Feeding back the sparse representation by the UE 115-a results in improvements in overhead of raw channel feedback because the UE 115-a is transmitting few non-zero elements rather than a significant number of raw channel estimations.

Accordingly, the UE 115-a may report the sparse channel representation to the network entity 105-a via uplink communication link 210 in accordance with the configuration. As the network entity 105-a has the sparsifying dictionary 215, the network entity 105-a may reconstruct the estimated raw channel using the dictionary 215 and the sparse channel representations from the UE 115-a. The network entity 105-a may use the raw channel estimated in a number of ways, including beam management.

In some cases, the sparsifying dictionary 215 may be associated with an identifier. For example, the UE 115-a may determine the identifier and transmit the identifier with the learned sparsifying dictionary 215. In some cases, the network entity 105-a may determine an identifier to correspond with the sparsifying dictionary 215 from UE 115-a. In such cases, the network entity 105-a may transmit an indication of the identifier to the UE 115-a. In either case, the UE 115-a may include the identifier in the report including the sparse channel representations so that the network entity 105-a may identify which sparsifying dictionary 215 to use to reconstruct the raw channel.

In some implementations, if there is a change (e.g., a significant change) in the environment (e.g., based on time of day such as day versus night, or if the UE 115 moves to a new zone or coverage area 110) the dictionary 215 may need to be re-learned, as the raw channel structure may be different. In some cases, the UE 115-a may autonomously determine to relearn the dictionary 215, and/or the UE 115-a may receive an indication to relearn the dictionary 215, such as via a signal from the network entity 105-a. Accordingly, upon learning an updated sparsifying dictionary 215, the UE 115-a may transmit the updated dictionary 215 to the network entity 105-a.

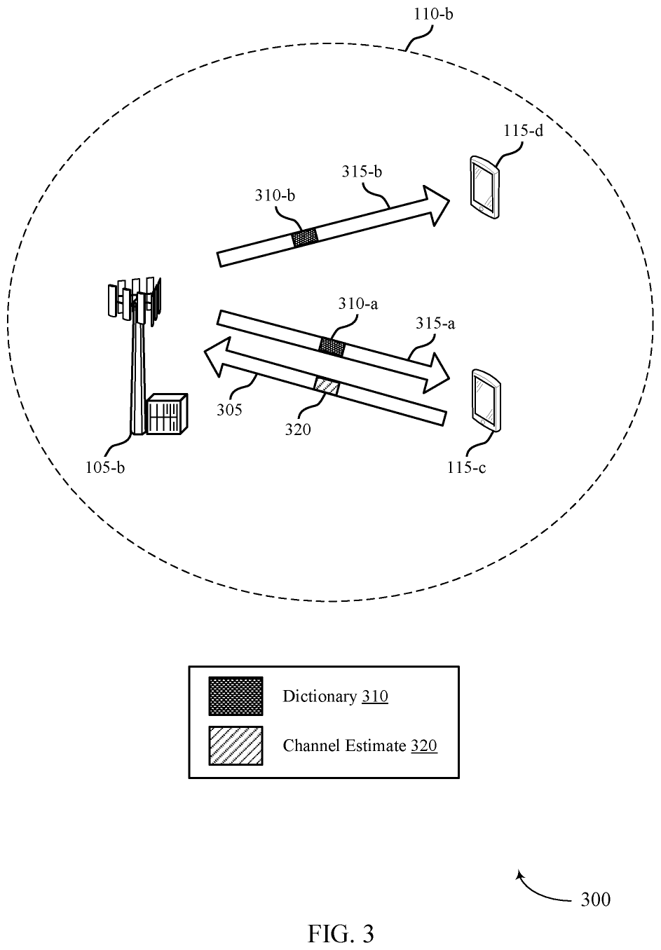

FIG. 3 illustrates an example of a wireless communications system 300 that supports signaling for dictionary learning techniques for channel estimation in accordance with one or more aspects of the present disclosure. In some examples, the wireless communications system 300 may implement aspects of a wireless communications system 100 and a wireless communications system 200. For example, the wireless communications system 300 may include a UE 115-c, a UE 115-d, and a network entity 105-b which may be examples of a UE 115 and a network entity 105 as described with reference to FIG. 1 and FIG. 2. In some examples, the UE 115-c, the UE 115-d, and the network entity 105-b may be located in a coverage area 110-b, which may be served by network entity 105-b, or some other network device.

In some examples, and as described with reference to FIG. 2, the network entity 105-b and the UE 115-c may determine optimal directional beams to use for communications with one another. In one example, the UE 115-c may transmit information (e.g., control information, data) to the network entity 105-b via an uplink communication link 305 (e.g., a channel, a beam), and the network entity 105-b may transmit information (e.g., control information, data) to the UE 115-c via a downlink communication link 315-a and the UE 115-d (e.g., a similar UE 115) via a downlink communication link 315-b.

In some examples, the network entity 105-b and the UE 115-c may undergo a beam management procedure to identify an optimal beam for communications between the network devices. In some examples, the wireless communications system 300 may perform beamformed channel measurements during a beam management procedure or during a different operation to determine channel information (e.g., estimate the underlying raw channel). As used herein, the raw channel may refer to the communications channel between the network entity 105-b and the UE 115-c in the absence of beamforming. Hence, the raw channel (and related channel state information) may be applicable to any signaling between the network entity 105-b and the UE 115-c, including beamformed signaling using any beam pair link (e.g., whether the beam pair link includes a predefined transmit beam and predefined receive beams based on the codebook, or whether the beam pair link includes one or more customized—e.g., non-codebook-based—beams).

As described herein, the UE 115-c, the UE 115-d, the network entity 105-b, or a combination thereof may use dictionary learning to determine channel information, which may then be used to select a customized beam for communications between devices. For example, the UE 115-c and/or the UE 115-d may be configured to log raw channel estimates as the UE 115 moves around a cell (e.g., the coverage area 110-b) to use as training samples for learning a dictionary 310 (e.g., a sparsifying dictionary 310). As described with reference to FIG. 2, the UEs 115 may be configured with a training sample threshold. For example, each UE 115 may be preconfigured with the threshold number, receive an indication of the threshold number (e.g., via RRC signaling, via MAC-control element (MAC-CE) signaling, via DCI signaling), or autonomously determine the threshold number of training samples, where each UE 115 may be configured with the same threshold, or with different thresholds. Accordingly, the UE 115-c and the UE 115-d collect training samples until each UE 115 satisfies a threshold number of training samples. Each training sample may be a function of time and location of the respective UE 115 that obtained the training sample.

In some cases, the network entity 105-b may be configured to determine the dictionary 310 based on the training samples obtained by one or more UEs 115, such as one or more UEs 115 in a zone (e.g., a subset of the coverage area 110-b), one or more UEs of the same type (e.g., similar devices that share the same antenna configuration, devices of the same or similar make, model, configuration, components, capabilities, or the like), one or more UEs in the coverage area 110-b, or the like. In such cases, the UEs 115 may be configured to transmit an indication of the training samples to the network entity 105-b. In some cases, each UE 115 may be configured to use sparse recovery algorithms (e.g., OMP or other types of algorithms) to estimate the underlaying raw channels using the obtained training samples. In some cases, the UE 115 may be configured to feedback the raw channel estimates to the network entity 105-b for use in learning the dictionary 310. In some examples, the network entity 105-b may configure for the UEs 115 to transmit the raw channel estimates for a given number of dominant taps. In some implementations, each UE 115 may be configured to compress the raw channel estimates. For example, each UE 115 may be preconfigured with to compress the estimates, receive an indication to compress the estimates (e.g., via RRC signaling, via MAC-CE signaling, via DCI signaling), or autonomously determine to compress the estimates, such as if the estimates exceed a threshold size. Each UE 115 may be configured to compress the estimates to some size. The UEs 115 may perform the compression through a trained auto-encoder, or other compression schemes, where the UEs 115 may be preconfigured with, receive an indication of, or autonomously determine the compression technique.

Upon compressing the channel estimates, each UE 115 may transmit the compressed version of the raw channel estimates to the network entity 105-b (e.g., channel estimates 320). For example, one or both of UE 115-c and UE 115-d may transmit channel estimates 320 to the network entity 105-b. Accordingly, the network entity 105-b may receive the raw channel estimates from one or more different UEs in the cell (e.g., zone, and/or coverage area 110-b) over a range of time. The network entity 105-b may use the compressed channel estimates from one or more of the UEs 115 to learn one or more sparsifying dictionaries 310.

In some cases, the network entity 105-b may categorize the raw channel estimates received from the similar UEs 115 and determine a sparsifying dictionary for a groups of similar UEs 115 (e.g., a dictionary 310-a for UE 115-c and a dictionary 310-b for UE 115-d). In such cases, the network entity 105-b may learn a sparsifying dictionary 310 for a group of similar UEs 115 based on channel estimates received from one or more of the UEs 115 in the group. The raw channel estimates used to compute a learned dictionary 310 may be relatively more diverse due to multiple similar UEs 115 logging the raw channel data. Similarly, the network entity 105-b may compute different dictionaries for different groups of UEs 115. For example, in some deployment scenarios there may be multiple UEs 115 (e.g., 120 UEs), the network entity 105-b may learn the sparsifying dictionaries based on the channel estimates of many of the UEs 115 (e.g., 100 UEs), and the network entity 105-b may test and validate the sparsifying dictionaries using the remaining UEs 115 (e.g., 20 UEs). The network entity 105-b may compute the learned sparsifying dictionaries 310 using one or more neural networks, machine learning, or the like.

The network entity 105-b may transmit the dictionaries 310 to respective UEs 115 such as via RRC signaling, MAC-CE signaling, and/or DCI signaling. For example, UE 115-c and UE 115-d may be similar UEs 115 and therefore, the network entity 105-b may transmit the learned dictionary 310 to one or both of UE 115-c and UE 115-d. In this example, the network entity 105-b may transmit a dictionary 310-a to the UE 115-c via a downlink communication link 315-a, and the network entity 105-b may transmit a dictionary 310-b to the UE 115-d via a downlink communication link 315-b, where dictionary 310-a and dictionary 310-b may be the same dictionary. In another example, UE 115-c and UE 115-d may not be similar UEs 115. Accordingly, the network entity 105-b may compute dictionary 310-a for UE 115-c based on channel estimates from UE 115-c (or some other device similar to UE 115-c), and the network entity 105-b may transmit the dictionary 310-a to UE 115-c. Similarly, the network entity 105-b may compute dictionary 310-b for UE 115-d based on channel estimates from UE 115-d (or some other device similar to UE 115-d), and the network entity 105-b may transmit the dictionary 310-b to UE 115-d, where dictionary 310-a and dictionary 310-b may be different.

In some examples, the network entity 105-b may transmit an indication of a zone, area, location, or any combination thereof, corresponding to each dictionary 310 (e.g., an applicable zone). For example, the dictionary may be applicable for a particular location in coverage area 110-b, for a certain time, for certain conditions, or the like. Accordingly, the network entity 105-b may indicate to the UE 115 the conditions under which the dictionary 310 is applicable. In some implementations, the network entity 105-b may transmit a signal indicating which UEs 115 (e.g., which type of UE 115) a learned dictionary 310 is applicable. In some cases, the signaling including the learned dictionary 310 may also include the characteristics of the UEs 115 for which the dictionary is applicable.

For example, the UE 115-c may move to another zone (e.g., another coverage area 110, or another zone within coverage area 110-b), and/or the network conditions may change and the learned dictionary 310-b may not be relevant in the new zone (and/or under the new conditions). In this example, the network entity 105-b, or some other device, may signal the dictionary 310 corresponding to the zone to the UE 115-c and/or the network entity 105-b may configure the UE 115-c to (re)transmit raw channel estimates associated with the new zone so that the network entity 105-b can compute a learned dictionary 310 for the new zone. For example, the UE 115-c may move from an indoor deployment to an urban micro (Umi) deployment, and the UE 115-c may be configured with a new dictionary 310 for the Umi deployment through RRC signaling, or some other control signaling.

The network entity 105-b and the UEs 115 may then use the learned sparsifying dictionary 310-b to determine an optimal beam pair between the network entity 105-b and each UE 115-c. Similarly, the network entity 105-b and the UE 115-d may use the learned sparsifying dictionary 310-a to determine an optimal beam pair between the network entity 105-b and the UE 115-d. For example, during an inference phase, the UE 115-c may use the learned dictionary 310 to estimate the underlying raw channel. In some examples, the network entity 105-b may transmit a signal indicating a configuration for the UE 115-c to transmit the sparse channel representation of dominant taps in the channel(s). Accordingly, the UE 115-c may transmit the indices of non-zero elements in the sparse channel representation along with a quantized version of the non-zero elements, which considerably reduces the overhead. Feeding back the sparse representation by the UE 115-c results in improvements in overhead of raw channel feedback because the UE 115-c is transmitting few non-zero elements rather than significant number of raw channel estimations.

Accordingly, the UE 115-c may report the sparse channel representation to the network entity 105-b via uplink communication link 305 in accordance with the configuration. As the network entity 105-b has the sparsifying dictionary 310-a, the network entity 105-b may reconstruct the estimated raw channel using the dictionary 310-a and the sparse channel representations from the UE 115-c. The network entity 105-b can use the raw channel estimated in a number of ways including beam management.

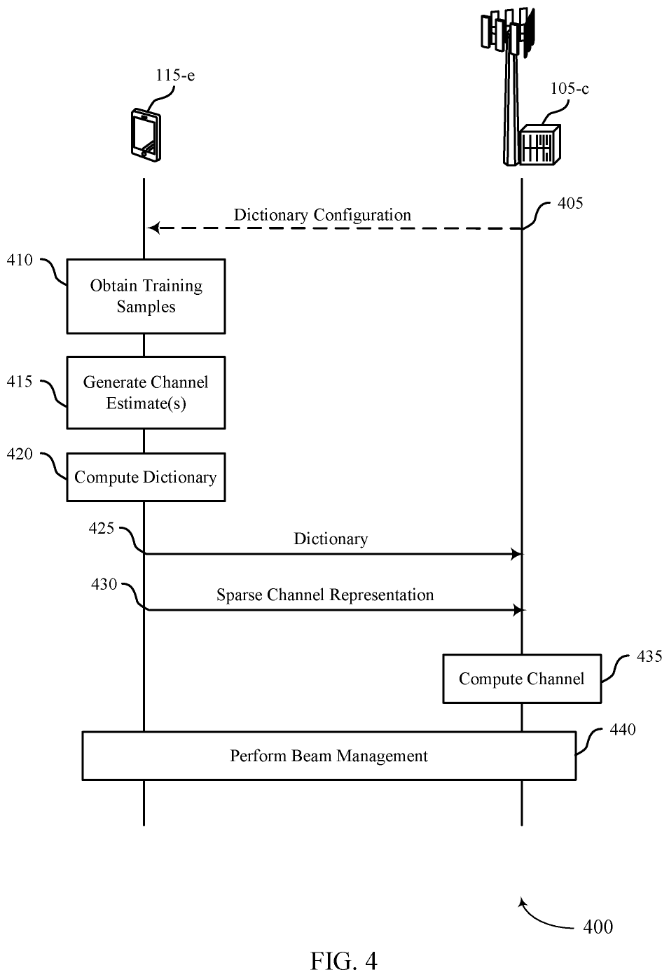

FIG. 4 illustrates an example of a process flow 400 in a system that supports signaling for dictionary learning techniques for channel estimation in accordance with one or more aspects of the present disclosure. In some examples, the process flow 400 may implement or be implemented by aspects of a wireless communications system 100 and a wireless communications system 200. For example, the process flow 400 may be implemented by a network entity 105-c and a UE 115-e which may be examples of a network entity 105 and a UE 115 as described with reference to FIGS. 1 and 2. Alternative examples of the following may be implemented, where some steps are performed in a different order then described or are not performed at all. In some cases, steps may include additional features not mentioned below, or further steps may be added.

At 405, in some examples, the network entity 105-c may transmit a signal indicating a configuration to transmit the sparse channel representation for a number of dominant taps. In some examples, the network entity 105-c may transmit a signal indicating a configuration of a threshold number of training samples to obtain prior to computing the dictionary. In some cases, the network entity 105-c may transmit a signal indicating a configuration of a set of parameters for computing the dictionary. The set of parameters may include criteria for stopping the learning procedure, a number of atoms to be included in the dictionary, or both.

At 410, the UE 115-e may obtain a number of training samples. In some examples, the UE 115-e may obtain the number of training samples that satisfies the threshold number of training samples. In some examples, the UE 115-e may obtain respective training samples at one or more locations of the UE 115-e, at one or more times of day, or both, where the one or more channel estimates may be based on the respective training samples.

At 415, the UE 115-e may generate channel estimate one or more channel estimates for a plurality of channels between the UE 115-e and the network entity 105-c using a sparse recovery technique, where the one or more channel estimates may be based on one or more measurements using a set of directional beams. In some examples, the UE 115-e may generate the one or more estimates using the sparse recovery technique by generating the one or more channel estimates using an OMP algorithm.

At 420, the UE 115-e may compute the dictionary associated with a sparse channel representation of a channel between the UE 115-e and the network entity 105-c based on a learning procedure using the one or more channel estimates. In some examples, the UE 115-e may compute the dictionary based on the number of training samples satisfying the threshold number of training samples. In some examples, the UE 115-e may compute the dictionary based on the set of parameters for configuring the dictionary. In some examples, the UE 115-e may compute an updated dictionary based on a change in one or more conditions for which the dictionary is dependent, where the indication of the dictionary may include an indication of the updated dictionary. The one or more conditions may include a location of the UE 115-e relatively to the network entity 105-c, a time of day, or both.

At 425, the UE 115-e may transmit a message comprising an indication of the dictionary to the network entity 105-c. In some examples, transmitting the message may be based on the threshold number of training samples being satisfied.

At 430, the UE 115-e may transmit a feedback message to the network entity 105-c indicating the sparse channel representation between the UE 115-e and the network entity 105-c. The feedback message may include a set of indices of non-zero elements in the sparse channel representation and a quantized set of the non-zero elements in the sparse channel representation. In some examples, the UE 115-e may transmit the feedback message based on the configuration to transmit the sparse channel representation for a number of dominant taps. In some examples, the UE 115-e may transmit an identifier of the dictionary associated with the sparse channel representation along with the feedback message.

At 435, the network entity 105-c may estimate the channel between the UE 115-e and the network entity 105-c using the dictionary and the sparse channel representation.

At 440, the network entity 105-c may perform a beam management procedure for selecting one or more directional beams based on the dictionary. The beam management procedure may be based on estimating the channel. The network entity 105-c may communicate with the UE 115-e using the one or more directional beams.

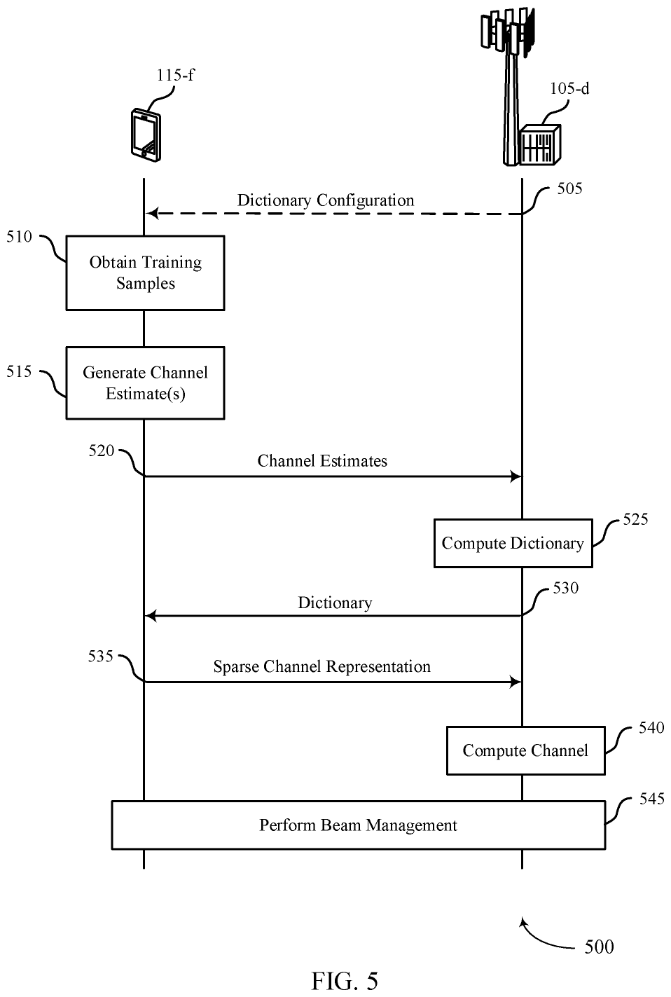

FIG. 5 illustrates an example of a process flow 500 in a system that supports signaling for dictionary learning techniques for channel estimation in accordance with one or more aspects of the present disclosure. In some examples, the process flow 500 may implement or be implemented by aspects of a wireless communications system 100 and a wireless communications system 300. For example, the process flow 500 may be implemented by a network entity 105-d and a UE 115-f which may be examples of a network entity 105 and a UE 115 as described with reference to FIGS. 1 and 3. Alternative examples of the following may be implemented, where some steps are performed in a different order then described or are not performed at all. In some cases, steps may include additional features not mentioned below, or further steps may be added.

At 505, in some examples, the network entity 105-d may transmit a signal indicating a configuration to transmit the sparse channel representation for a number of dominant taps. In some examples, the network entity 105-d may transmit a signal indicating a configuration of a threshold number of training samples to obtain prior to computing the dictionary. In some cases, the network entity 105-d may transmit a signal indicating a configuration of a set of parameters for computing the dictionary. The set of parameters may include criteria for stopping the learning procedure, a number of atoms to be included in the dictionary, or both.

At 510, the UE 115-f may obtain a number of training samples. In some examples, the UE 115-f may obtain the number of training samples that satisfies the threshold number of training samples. In some examples, the UE 115-e may obtain respective training samples at one or more locations of the UE 115-f, at one or more times of day, or both, where the one or more channel estimates may be based on the respective training samples.

At 515, the UE 115-f may generate one or more channel estimates for a plurality of channels between the UE 115-f and the network entity 105-d using a sparse recovery technique, where the one or more channel estimates may be based on one or more measurements using a set of directional beams. In some examples, the UE 115-f may generate the one or more estimates using the sparse recovery technique by generating the one or more channel estimates using the OMP algorithm. In some examples, the UE 115-f may perform an operation to compress the one or more channel estimates. The operation to compress the one or more channel estimates based be based on an auto-encoder, one or more compression schemes, or both.

At 520, the UE 115-f may transmit a signal indicating the one or more channel estimates to the network entity 105-d. In some examples, the signal indicating the one or more channel estimates may include the compressed one or more channel estimates. In some examples, the signal indicating the one or more channel estimates may include compressed version of the one or more channel estimates.

At 525, the network entity 105-d may compute the dictionary associated with the sparse channel representation of the channel between the UE 115-f and the network entity 105-d based on a learning procedure using the one or more channel estimates.

At 530, the network entity 105-d may transmit one or more messages each comprising an indication of the dictionary to one or more other UEs 115 and UE 115-f. The dictionary may be based on the one or more channel estimates. The one or more UEs 115 may be one or more of same antenna configuration as the UE 115-f, associated with a same manufacturer as the UE 115-f, a same model as the UE 115-f, or a same type as the UE 115-f In some examples, the one or more UEs 115 may receive, in the message, an indication of a set of one or more conditions for which the dictionary is applicable. The set of one or more conditions may include one or more of a geographic location, a time of day, or a zone. In some examples, the network entity 105-d may transmit a second message including an indication of a second dictionary associated with a second channel between the UE 115-f and the network entity 105-d based at least in part on a change in one or more conditions for which the dictionary may be dependent. In some examples, the message may include an RRC message.

At 535, the UE 115-f may transmit a feedback message indicating the sparse channel representation of the channel between the UE 115-f and the network entity 105-d. The feedback message may include a set of indices of non-zero elements in the sparse channel representation and a quantized set of the non-zero elements in the sparse channel representation. In some examples, the UE 115-f may transmit the feedback message based on the configuration to transmit the sparse channel representation for a number of dominant taps. In some examples, the UE 115-f may transmit an identifier of the dictionary associated with the sparse channel representation along with the feedback message.

At 540, the network entity 105-d may estimate the channel between the UE 115-f and the network entity 105-d using the dictionary and the sparse channel representation.

At 545, the network entity 105-d may perform a beam management procedure for selecting one or more directional beams based on the dictionary. The beam management procedure may be based on estimating the channel. The network entity 105-d may communicate with the UE 115-f using the one or more directional beams.

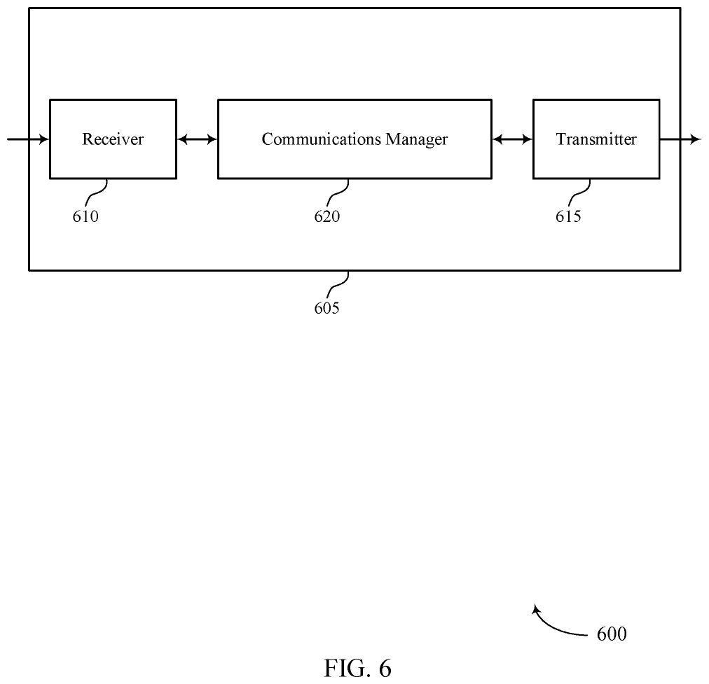

FIG. 6 shows a block diagram 600 of a device 605 that supports signaling for dictionary learning techniques for channel estimation in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling for dictionary learning techniques for channel estimation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling for dictionary learning techniques for channel estimation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of signaling for dictionary learning techniques for channel estimation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for generating one or more channel estimates for a set of multiple channels between the UE and a network entity using a sparse recovery technique, where the one or more channel estimates are based on one or more measurements using a set of directional beams. The communications manager 620 may be configured as or otherwise support a means for computing a dictionary associated with a sparse channel representation of a channel between the UE and the network entity based on a learning procedure using the one or more channel estimates. The communications manager 620 may be configured as or otherwise support a means for transmitting a message including an indication of the dictionary to the network entity.

Additionally, or alternatively, the communications manager 620 may support wireless communication at a UE in accordance with examples as disclosed herein. For example, the communications manager 620 may be configured as or otherwise support a means for generating one or more channel estimates for a set of multiple channels between the UE and a network entity using a sparse recovery technique, where the one or more channel estimates are based on one or more measurements using a set of directional beams. The communications manager 620 may be configured as or otherwise support a means for transmitting a signal indicating the one or more channel estimates to the network entity. The communications manager 620 may be configured as or otherwise support a means for receiving a message including an indication of a dictionary associated with a sparse channel representation of a channel between the UE and the network entity, the dictionary being based on the one or more channel estimates.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and reduced power consumption.

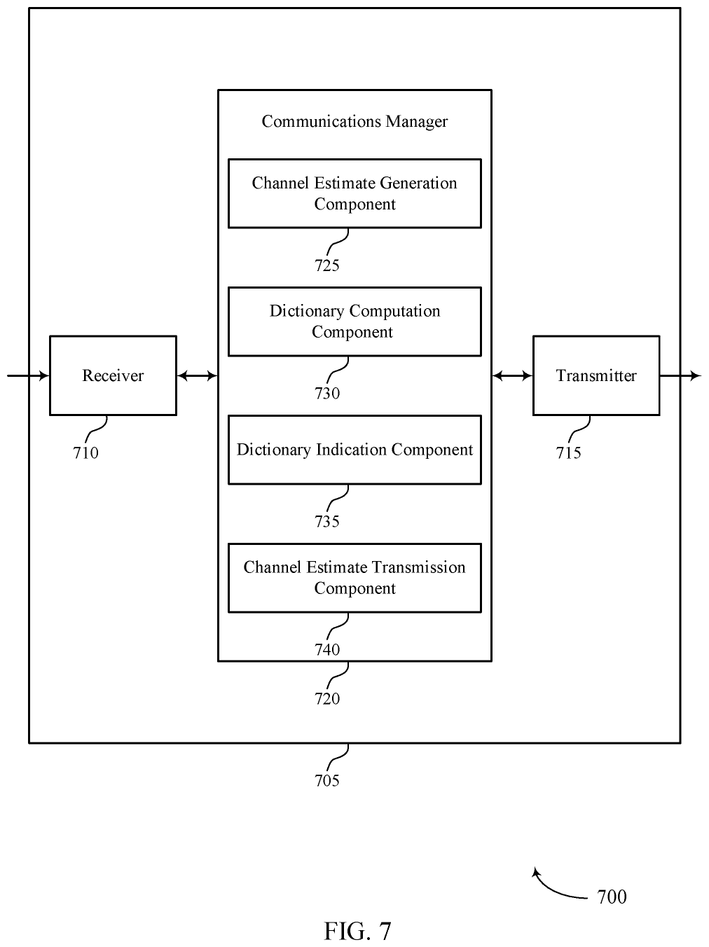

FIG. 7 shows a block diagram 700 of a device 705 that supports signaling for dictionary learning techniques for channel estimation in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling for dictionary learning techniques for channel estimation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling for dictionary learning techniques for channel estimation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of signaling for dictionary learning techniques for channel estimation as described herein. For example, the communications manager 720 may include a channel estimate generation component 725, a dictionary computation component 730, a dictionary indication component 735, a channel estimate transmission component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The channel estimate generation component 725 may be configured as or otherwise support a means for generating one or more channel estimates for a set of multiple channels between the UE and a network entity using a sparse recovery technique, where the one or more channel estimates are based on one or more measurements using a set of directional beams. The dictionary computation component 730 may be configured as or otherwise support a means for computing a dictionary associated with a sparse channel representation of a channel between the UE and the network entity based on a learning procedure using the one or more channel estimates. The dictionary indication component 735 may be configured as or otherwise support a means for transmitting a message including an indication of the dictionary to the network entity.

Additionally, or alternatively, the communications manager 720 may support wireless communication at a UE in accordance with examples as disclosed herein. The channel estimate generation component 725 may be configured as or otherwise support a means for generating one or more channel estimates for a set of multiple channels between the UE and a network entity using a sparse recovery technique, where the one or more channel estimates are based on one or more measurements using a set of directional beams. The channel estimate transmission component 740 may be configured as or otherwise support a means for transmitting a signal indicating the one or more channel estimates to the network entity. The dictionary indication component 735 may be configured as or otherwise support a means for receiving a message including an indication of a dictionary associated with a sparse channel representation of a channel between the UE and the network entity, the dictionary being based on the one or more channel estimates.

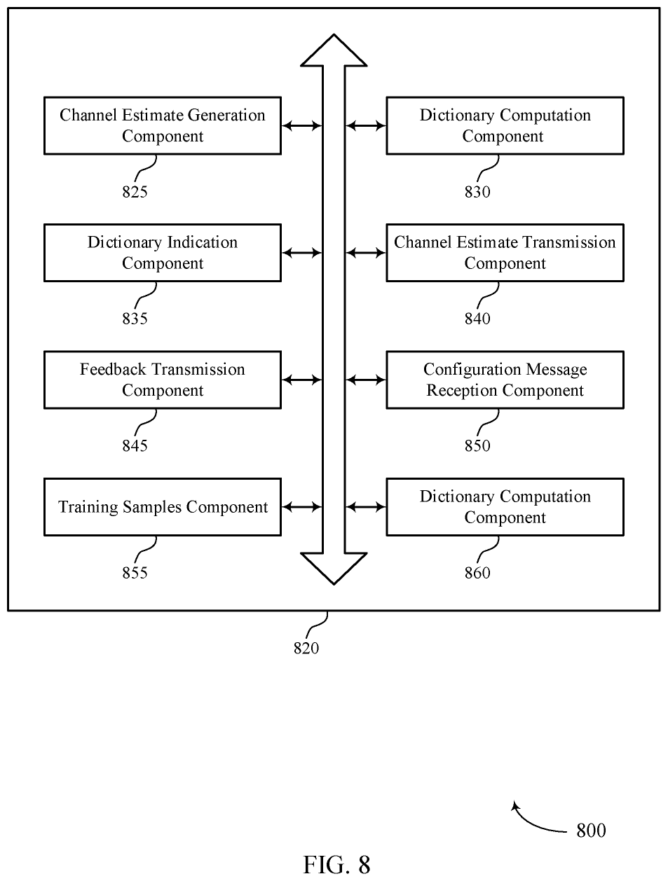

FIG. 8 shows a block diagram 800 of a communications manager 820 that supports signaling for dictionary learning techniques for channel estimation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of signaling for dictionary learning techniques for channel estimation as described herein. For example, the communications manager 820 may include a channel estimate generation component 825, a dictionary computation component 830, a dictionary indication component 835, a channel estimate transmission component 840, a feedback transmission component 845, a configuration message reception component 850, a training samples component 855, a dictionary computation component 860, or any combination thereof. Each of these components may communicate, directly or indirectly, with one another (e.g., via one or more buses).

The communications manager 820 may support wireless communication at a UE in accordance with examples as disclosed herein. The channel estimate generation component 825 may be configured as or otherwise support a means for generating one or more channel estimates for a set of multiple channels between the UE and a network entity using a sparse recovery technique, where the one or more channel estimates are based on one or more measurements using a set of directional beams. The dictionary computation component 830 may be configured as or otherwise support a means for computing a dictionary associated with a sparse channel representation of a channel between the UE and the network entity based on a learning procedure using the one or more channel estimates. The dictionary indication component 835 may be configured as or otherwise support a means for transmitting a message including an indication of the dictionary to the network entity.

In some examples, the feedback transmission component 845 may be configured as or otherwise support a means for transmitting a feedback message indicating the sparse channel representation of the channel between the UE and the network entity, the feedback message including a set of indices of non-zero elements in the sparse channel representation and a quantized set of the non-zero elements in the sparse channel representation.

In some examples, the configuration message reception component 850 may be configured as or otherwise support a means for receiving a signal indicating a configuration to transmit the sparse channel representation for a number of dominant taps of the channel, where transmitting the feedback message is based on the configuration.

In some examples, to support transmitting the feedback message, the feedback transmission component 845 may be configured as or otherwise support a means for transmitting, with the feedback message, an identifier of the dictionary associated with the sparse channel representation.

In some examples, the configuration message reception component 850 may be configured as or otherwise support a means for receiving a signal indicating a configuration of a threshold number of training samples to obtain prior to computing the dictionary, where transmitting the message is based on the threshold number of training samples being satisfied.

In some examples, the training samples component 855 may be configured as or otherwise support a means for obtaining a number of training samples that at least satisfies the threshold number of training samples, where the UE computes the dictionary based on the number of training samples satisfying the threshold.

In some examples, the training samples component 855 may be configured as or otherwise support a means for obtaining respective training samples at one or more locations of the UE, at one or more times of day, or a combination thereof, where the one or more channel estimates are based on the respective training samples.

In some examples, the configuration message reception component 850 may be configured as or otherwise support a means for receiving a signal indicating a configuration of a set of parameters for computing the dictionary, the set of parameters including criteria for stopping the learning procedure, a number of atoms to be included in the dictionary, or a combination thereof, where the dictionary is computed in accordance with the set of parameters.

In some examples, the dictionary computation component 860 may be configured as or otherwise support a means for computing an updated dictionary based on a change in one or more conditions for which the dictionary is dependent, where the indication of the dictionary includes an indication of the updated dictionary.

In some examples, the one or more conditions include a location of the UE relative to the network entity, a time of day, or a combination thereof.

In some examples, to support generating the one or more channel estimates using the sparse recovery technique, the channel estimate generation component 825 may be configured as or otherwise support a means for generating the one or more channel estimates using an orthogonal matching pursuit (OMP) algorithm.

Additionally, or alternatively, the communications manager 820 may support wireless communication at a UE in accordance with examples as disclosed herein. In some examples, the channel estimate generation component 825 may be configured as or otherwise support a means for generating one or more channel estimates for a set of multiple channels between the UE and a network entity using a sparse recovery technique, where the one or more channel estimates are based on one or more measurements using a set of directional beams. The channel estimate transmission component 840 may be configured as or otherwise support a means for transmitting a signal indicating the one or more channel estimates to the network entity. In some examples, the dictionary indication component 835 may be configured as or otherwise support a means for receiving a message including an indication of a dictionary associated with a sparse channel representation of a channel between the UE and the network entity, the dictionary being based on the one or more channel estimates.

In some examples, the feedback transmission component 845 may be configured as or otherwise support a means for transmitting, after receiving the dictionary, a feedback message indicating the sparse channel representation of the channel between the UE and the network entity, the feedback message including a set of indices of non-zero elements in the sparse channel representation and a quantized set of the non-zero elements in the sparse channel representation.

In some examples, the configuration message reception component 850 may be configured as or otherwise support a means for receiving a signal indicating a configuration to transmit the sparse channel representation for a number of dominant taps of the channel, where transmitting the feedback message is based on the configuration.

In some examples, to support transmitting the feedback message, the feedback transmission component 845 may be configured as or otherwise support a means for transmitting, with the feedback message, an identifier of the dictionary associated with the sparse channel representation.

In some examples, the dictionary indication component 835 may be configured as or otherwise support a means for receiving, in the message, an indication of a set of one or more characteristics associated with a set of UEs for which the dictionary is applicable.

In some examples, the dictionary indication component 835 may be configured as or otherwise support a means for receiving, in the message, an indication of set of one or more conditions for which the dictionary is applicable, the set of one or more conditions including a geographic location, a time of day, a zone, or a combination thereof.

In some examples, the channel estimate generation component 825 may be configured as or otherwise support a means for performing an operation to compress the one or more channel estimates, where the signal indicating the one or more channel estimates includes the compressed one or more channel estimates.

In some examples, performing the operation to compress the one or more channel estimates is based on an auto-encoder, one or more compression schemes, or a combination thereof.

In some examples, the configuration message reception component 850 may be configured as or otherwise support a means for receiving a signal indicating a configuration to transmit the indication of the one or more channel estimates for a number of dominant taps of the channel, where transmitting the signal is based on the configuration.

In some examples, the dictionary indication component 835 may be configured as or otherwise support a means for receiving a second message including an indication of a second dictionary associated with a second channel between the UE and the network entity based on a change in one or more conditions for which the dictionary is dependent.

In some examples, the one or more conditions include a location of the UE relative to the network entity, a time of day, or a combination thereof.

In some examples, the training samples component 855 may be configured as or otherwise support a means for obtaining respective training samples at one or more locations of the UE, at one or more times of day, or a combination thereof, where the one or more channel estimates are based on the respective training samples.

In some examples, to support generating the one or more channel estimates using the sparse recovery technique, the channel estimate generation component 825 may be configured as or otherwise support a means for generating the one or more channel estimates using an orthogonal matching pursuit (OMP) algorithm.

In some examples, the message includes a radio resource control message.

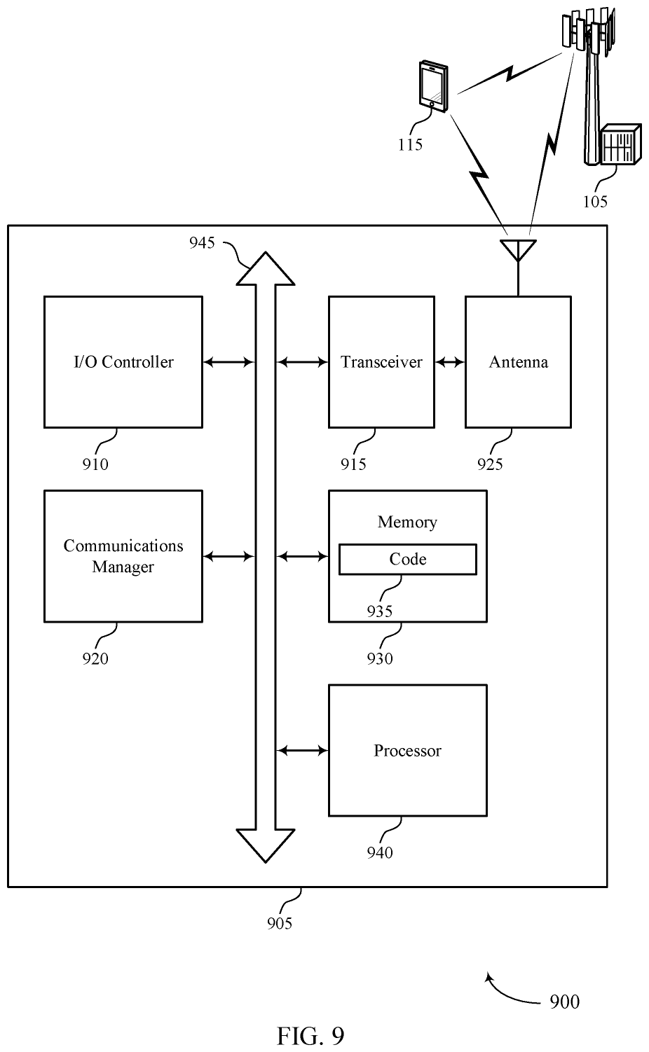

FIG. 9 shows a diagram of a system 900 including a device 905 that supports signaling for dictionary learning techniques for channel estimation in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting signaling for dictionary learning techniques for channel estimation). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for generating one or more channel estimates for a set of multiple channels between the UE and a network entity using a sparse recovery technique, where the one or more channel estimates are based on one or more measurements using a set of directional beams. The communications manager 920 may be configured as or otherwise support a means for computing a dictionary associated with a sparse channel representation of a channel between the UE and the network entity based on a learning procedure using the one or more channel estimates. The communications manager 920 may be configured as or otherwise support a means for transmitting a message including an indication of the dictionary to the network entity.

Additionally, or alternatively, the communications manager 920 may support wireless communication at a UE in accordance with examples as disclosed herein. For example, the communications manager 920 may be configured as or otherwise support a means for generating one or more channel estimates for a set of multiple channels between the UE and a network entity using a sparse recovery technique, where the one or more channel estimates are based on one or more measurements using a set of directional beams. The communications manager 920 may be configured as or otherwise support a means for transmitting a signal indicating the one or more channel estimates to the network entity. The communications manager 920 may be configured as or otherwise support a means for receiving a message including an indication of a dictionary associated with a sparse channel representation of a channel between the UE and the network entity, the dictionary being based on the one or more channel estimates.

By including or configuring the communications manager 920 in accordance with examples as described herein, the device 905 may support techniques for reduced latency and reduced power consumption.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of signaling for dictionary learning techniques for channel estimation as described herein, or the processor 940 and the memory 930 may be otherwise configured to perform or support such operations.

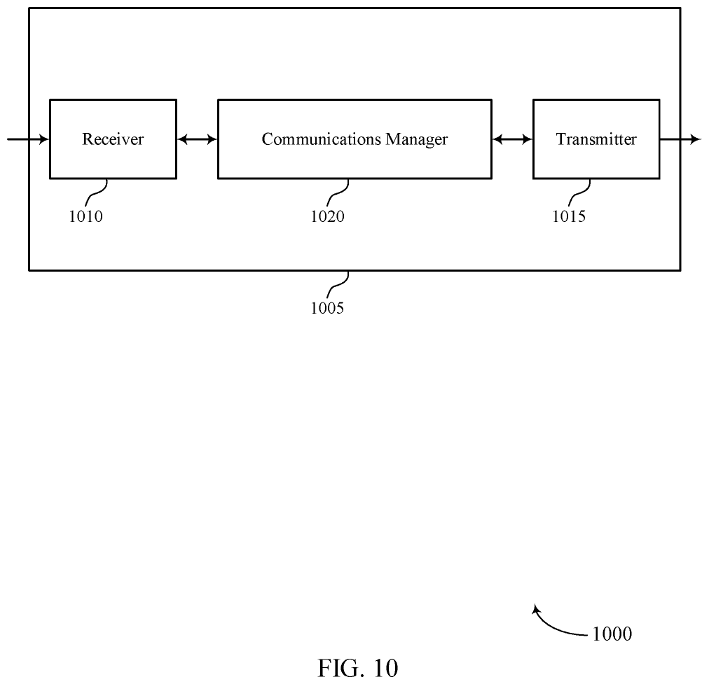

FIG. 10 shows a block diagram 1000 of a device 1005 that supports signaling for dictionary learning techniques for channel estimation in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of signaling for dictionary learning techniques for channel estimation as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for receiving a message including an indication of a dictionary associated with a sparse channel representation of a channel between a UE and the network entity. The communications manager 1020 may be configured as or otherwise support a means for performing a beam management procedure for selecting one or more directional beams based on the dictionary. The communications manager 1020 may be configured as or otherwise support a means for communicating with the UE using the one or more directional beams.

Additionally, or alternatively, the communications manager 1020 may support wireless communication at a network entity in accordance with examples as disclosed herein. For example, the communications manager 1020 may be configured as or otherwise support a means for receiving, from each UE of a set of one or more UEs, respective signals indicating one or more channel estimates for a set of multiple channels between each UE and the network entity. The communications manager 1020 may be configured as or otherwise support a means for computing a dictionary associated with a sparse channel representation of a channel between the UE and the network entity based on a learning procedure using the one or more channel estimates. The communications manager 1020 may be configured as or otherwise support a means for transmitting a message including an indication of the dictionary to a UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing and reduced power consumption.

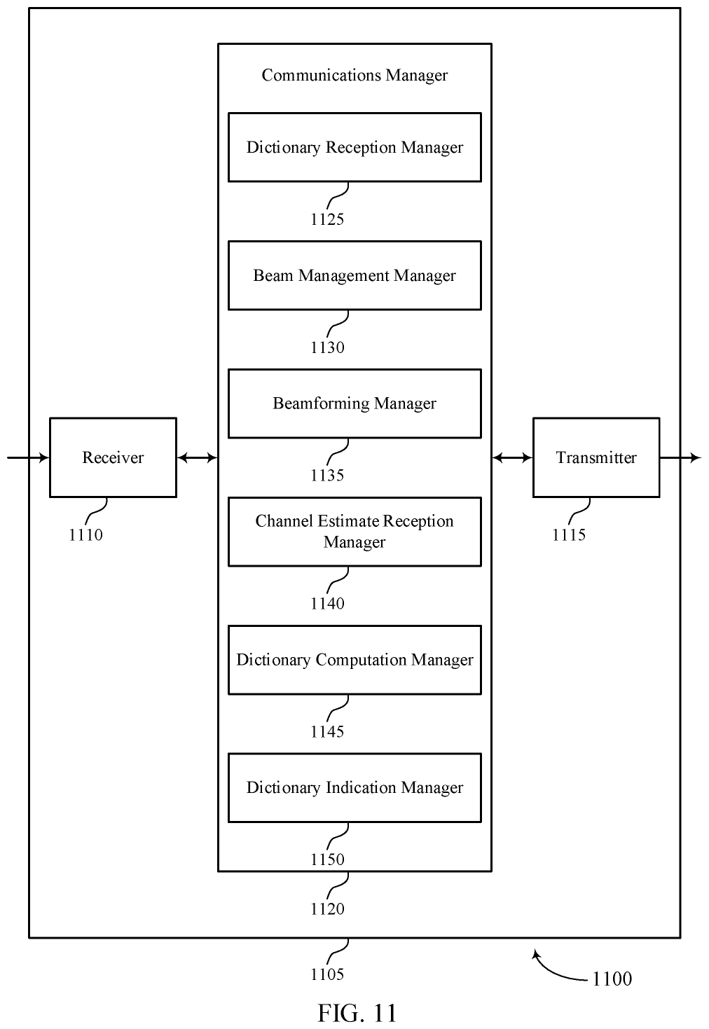

FIG. 11 shows a block diagram 1100 of a device 1105 that supports signaling for dictionary learning techniques for channel estimation in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of signaling for dictionary learning techniques for channel estimation as described herein. For example, the communications manager 1120 may include a dictionary reception manager 1125, a beam management manager 1130, a beamforming manager 1135, a channel estimate reception manager 1140, a dictionary computation manager 1145, a dictionary indication manager 1150, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The dictionary reception manager 1125 may be configured as or otherwise support a means for receiving a message including an indication of a dictionary associated with a sparse channel representation of a channel between a UE and the network entity. The beam management manager 1130 may be configured as or otherwise support a means for performing a beam management procedure for selecting one or more directional beams based on the dictionary. The beamforming manager 1135 may be configured as or otherwise support a means for communicating with the UE using the one or more directional beams.

Additionally, or alternatively, the communications manager 1120 may support wireless communication at a network entity in accordance with examples as disclosed herein. The channel estimate reception manager 1140 may be configured as or otherwise support a means for receiving, from each UE of a set of one or more UEs, respective signals indicating one or more channel estimates for a set of multiple channels between each UE and the network entity. The dictionary computation manager 1145 may be configured as or otherwise support a means for computing a dictionary associated with a sparse channel representation of a channel between the UE and the network entity based on a learning procedure using the one or more channel estimates. The dictionary indication manager 1150 may be configured as or otherwise support a means for transmitting a message including an indication of the dictionary to a UE.

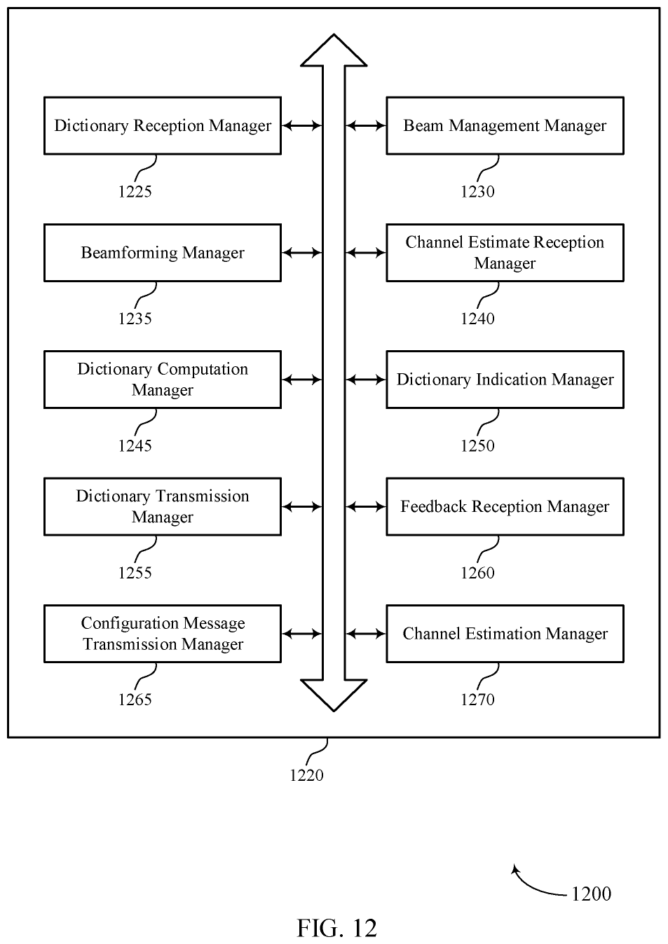

FIG. 12 shows a block diagram 1200 of a communications manager 1220 that supports signaling for dictionary learning techniques for channel estimation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of signaling for dictionary learning techniques for channel estimation as described herein. For example, the communications manager 1220 may include a dictionary reception manager 1225, a beam management manager 1230, a beamforming manager 1235, a channel estimate reception manager 1240, a dictionary computation manager 1245, a dictionary indication manager 1250, a dictionary transmission manager 1255, a feedback reception manager 1260, a configuration message transmission manager 1265, a channel estimation manager 1270, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The dictionary reception manager 1225 may be configured as or otherwise support a means for receiving a message including an indication of a dictionary associated with a sparse channel representation of a channel between a UE and the network entity. The beam management manager 1230 may be configured as or otherwise support a means for performing a beam management procedure for selecting one or more directional beams based on the dictionary. The beamforming manager 1235 may be configured as or otherwise support a means for communicating with the UE using the one or more directional beams.

In some examples, the dictionary transmission manager 1255 may be configured as or otherwise support a means for transmitting, to one or more other UEs, one or more messages each including an indication of the dictionary, the one or more other UEs having a same antenna configuration as the UE, being associated with a same manufacturer as the UE, being a same model as the UE, being a same type as the UE, or a combination thereof.

In some examples, the feedback reception manager 1260 may be configured as or otherwise support a means for receiving a feedback message indicating the sparse channel representation of the channel between the UE and the network entity, the feedback message including a set of indices of non-zero elements in the sparse channel representation and a quantized set of the non-zero elements in the sparse channel representation.

In some examples, the configuration message transmission manager 1265 may be configured as or otherwise support a means for transmitting a signal indicating a configuration for transmitting the sparse channel representation for a number of dominant taps of the channel, where receiving the feedback message is based on the configuration.

In some examples, to support receiving the feedback message, the feedback reception manager 1260 may be configured as or otherwise support a means for receiving, with the feedback message, an identifier of the dictionary associated with the sparse channel representation.

In some examples, the channel estimation manager 1270 may be configured as or otherwise support a means for estimating the channel between the UE and the network entity using the dictionary and the sparse channel representation, where performing the beam management procedure is based on estimating the channel.

In some examples, the configuration message transmission manager 1265 may be configured as or otherwise support a means for transmitting a signal indicating a configuration of a threshold number of training samples for computing the dictionary, where receiving the message is based on the threshold number of training samples being satisfied.

In some examples, the configuration message transmission manager 1265 may be configured as or otherwise support a means for transmitting a signal indicating a configuration of a set of parameters for computing the dictionary, the set of parameters including criteria for stopping a learning procedure, a number of atoms to be included in the dictionary, or a combination thereof, where the dictionary is based on the set of parameters.

In some examples, the indication of the dictionary includes an indication of an updated dictionary that has been updated based on a change in one or more conditions for which the dictionary is dependent.

In some examples, the one or more conditions include a location of the UE relative to the network entity, a time of day, or a combination thereof.

Additionally, or alternatively, the communications manager 1220 may support wireless communication at a network entity in accordance with examples as disclosed herein. The channel estimate reception manager 1240 may be configured as or otherwise support a means for receiving, from each UE of a set of one or more UEs, respective signals indicating one or more channel estimates for a set of multiple channels between each UE and the network entity. The dictionary computation manager 1245 may be configured as or otherwise support a means for computing a dictionary associated with a sparse channel representation of a channel between the UE and the network entity based on a learning procedure using the one or more channel estimates. The dictionary indication manager 1250 may be configured as or otherwise support a means for transmitting a message including an indication of the dictionary to a UE.

In some examples, the feedback reception manager 1260 may be configured as or otherwise support a means for receiving, after transmitting the dictionary, a feedback message indicating the sparse channel representation of the channel between the UE and the network entity, the feedback message including a set of indices of non-zero elements in the sparse channel representation and a quantized set of the non-zero elements in the sparse channel representation.

In some examples, the channel estimation manager 1270 may be configured as or otherwise support a means for estimating the channel between the UE and the network entity using the dictionary and the sparse channel representation. In some examples, the beam management manager 1230 may be configured as or otherwise support a means for performing a beam management procedure for selecting one or more directional beams based on estimating the channel.

In some examples, the configuration message transmission manager 1265 may be configured as or otherwise support a means for transmitting a signal indicating a configuration for transmitting the sparse channel representation for a number of dominant taps of the channel, where receiving the feedback message is based on the configuration.

In some examples, to support transmitting the feedback message, the feedback reception manager 1260 may be configured as or otherwise support a means for receiving, with the feedback message, an identifier of the dictionary associated with the sparse channel representation.

In some examples, the dictionary indication manager 1250 may be configured as or otherwise support a means for transmitting, in the message, an indication of a set of one or more characteristics associated with a set of UEs for which the dictionary is applicable.

In some examples, the dictionary indication manager 1250 may be configured as or otherwise support a means for transmitting, in the message, an indication of set of one or more conditions for which the dictionary is applicable, the set of one or more conditions including a geographic location, a time of day, a zone, or a combination thereof.

In some examples, the configuration message transmission manager 1265 may be configured as or otherwise support a means for transmitting a signal indicating a configuration for transmitting the one or more channel estimates for a number of dominant taps of the channel, where the network entity receives the one or more channel estimates for the number of dominant taps.

In some examples, the dictionary indication manager 1250 may be configured as or otherwise support a means for transmitting a second message including an indication of a second dictionary associated with a second channel between the UE and the network entity based on a change in one or more conditions for which the dictionary is dependent.

In some examples, the one or more conditions include a location of the UE relative to the network entity, a time of day, or a combination thereof.

In some examples, the respective signals indicating the one or more channel estimates includes compressed versions of the one or more channel estimates.

In some examples, computing the dictionary is based on each UE of the set of one or more UEs having a same antenna configuration, being associated with a same manufacturer, being a same model, being a same type, or a combination thereof.

In some examples, the message includes a radio resource control message.

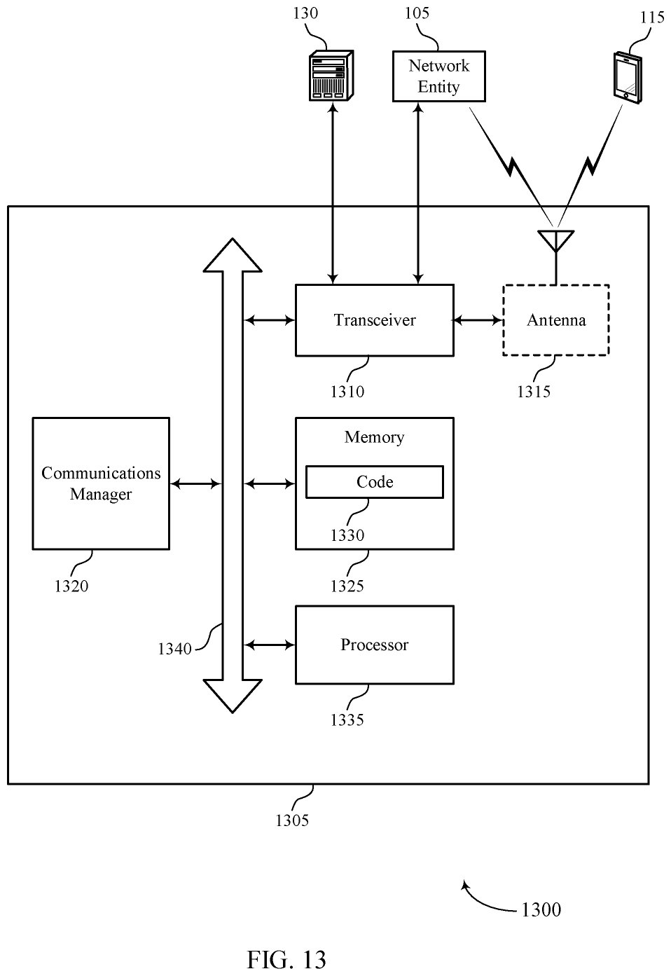

FIG. 13 shows a diagram of a system 1300 including a device 1305 that supports signaling for dictionary learning techniques for channel estimation in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting signaling for dictionary learning techniques for channel estimation). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for receiving a message including an indication of a dictionary associated with a sparse channel representation of a channel between a UE and the network entity. The communications manager 1320 may be configured as or otherwise support a means for performing a beam management procedure for selecting one or more directional beams based on the dictionary. The communications manager 1320 may be configured as or otherwise support a means for communicating with the UE using the one or more directional beams.

Additionally, or alternatively, the communications manager 1320 may support wireless communication at a network entity in accordance with examples as disclosed herein. For example, the communications manager 1320 may be configured as or otherwise support a means for receiving, from each UE of a set of one or more UEs, respective signals indicating one or more channel estimates for a set of multiple channels between each UE and the network entity. The communications manager 1320 may be configured as or otherwise support a means for computing a dictionary associated with a sparse channel representation of a channel between the UE and the network entity based on a learning procedure using the one or more channel estimates. The communications manager 1320 may be configured as or otherwise support a means for transmitting a message including an indication of the dictionary to a UE.

By including or configuring the communications manager 1320 in accordance with examples as described herein, the device 1305 may support techniques for reduced latency and reduced power consumption.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of signaling for dictionary learning techniques for channel estimation as described herein, or the processor 1335 and the memory 1325 may be otherwise configured to perform or support such operations.

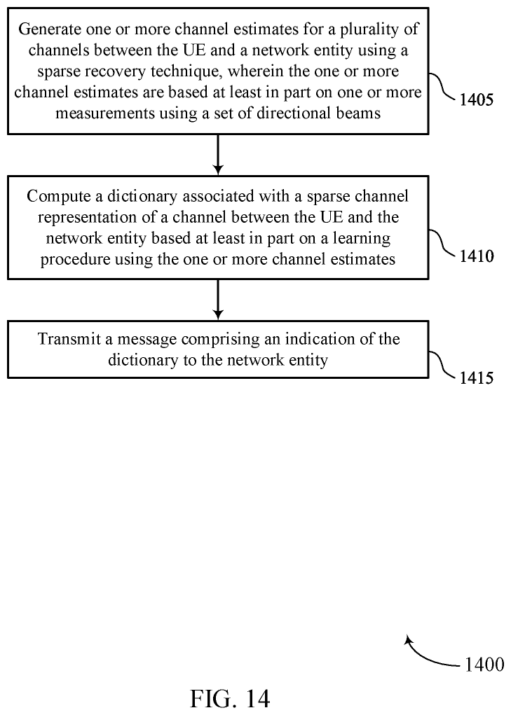

FIG. 14 shows a flowchart illustrating a method 1400 that supports signaling for dictionary learning techniques for channel estimation in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include generating one or more channel estimates for a set of multiple channels between the UE and a network entity using a sparse recovery technique, where the one or more channel estimates are based on one or more measurements using a set of directional beams. The operations of 1405 may be performed in accordance with examples as disclosed herein. In some examples, aspects of the operations of 1405 may be performed by a channel estimate generation component 825 as described with reference to FIG. 8.

At 1410, the method may include computing a dictionary associated with a sparse channel representation of a channel between the UE and the network entity based on a learning procedure using the one or more channel estimates. The operations of 1410 may be performed in accordance with examples as disclosed herein. In some examples, aspects of the operations of 1410 may be performed by a dictionary computation component 830 as described with reference to FIG. 8.

At 1415, the method may include transmitting a message including an indication of the dictionary to the network entity. The operations of 1415 may be performed in accordance with examples as disclosed herein. In some examples, aspects of the operations of 1415 may be performed by a dictionary indication component 835 as described with reference to FIG. 8.

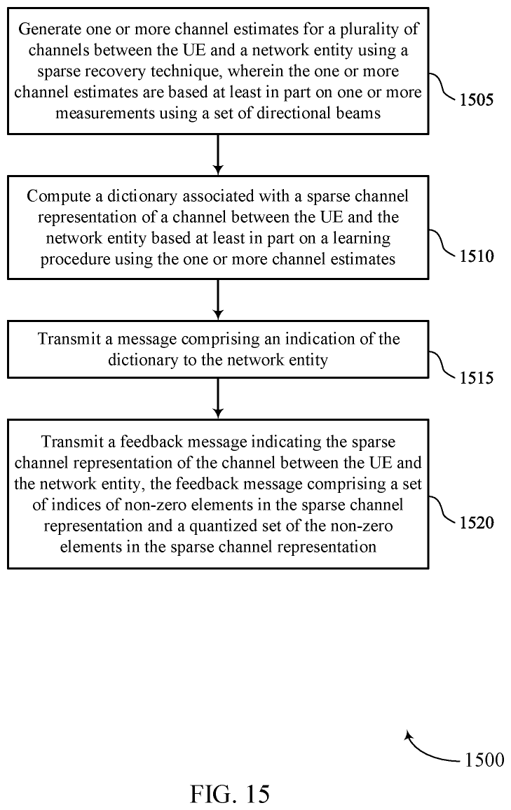

FIG. 15 shows a flowchart illustrating a method 1500 that supports signaling for dictionary learning techniques for channel estimation in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include generating one or more channel estimates for a set of multiple channels between the UE and a network entity using a sparse recovery technique, where the one or more channel estimates are based on one or more measurements using a set of directional beams. The operations of 1505 may be performed in accordance with examples as disclosed herein. In some examples, aspects of the operations of 1505 may be performed by a channel estimate generation component 825 as described with reference to FIG. 8.

At 1510, the method may include computing a dictionary associated with a sparse channel representation of a channel between the UE and the network entity based on a learning procedure using the one or more channel estimates. The operations of 1510 may be performed in accordance with examples as disclosed herein. In some examples, aspects of the operations of 1510 may be performed by a dictionary computation component 830 as described with reference to FIG. 8.

At 1515, the method may include transmitting a message including an indication of the dictionary to the network entity. The operations of 1515 may be performed in accordance with examples as disclosed herein. In some examples, aspects of the operations of 1515 may be performed by a dictionary indication component 835 as described with reference to FIG. 8.

At 1520, the method may include transmitting a feedback message indicating the sparse channel representation of the channel between the UE and the network entity, the feedback message including a set of indices of non-zero elements in the sparse channel representation and a quantized set of the non-zero elements in the sparse channel representation. The operations of 1520 may be performed in accordance with examples as disclosed herein. In some examples, aspects of the operations of 1520 may be performed by a feedback transmission component 845 as described with reference to FIG. 8.

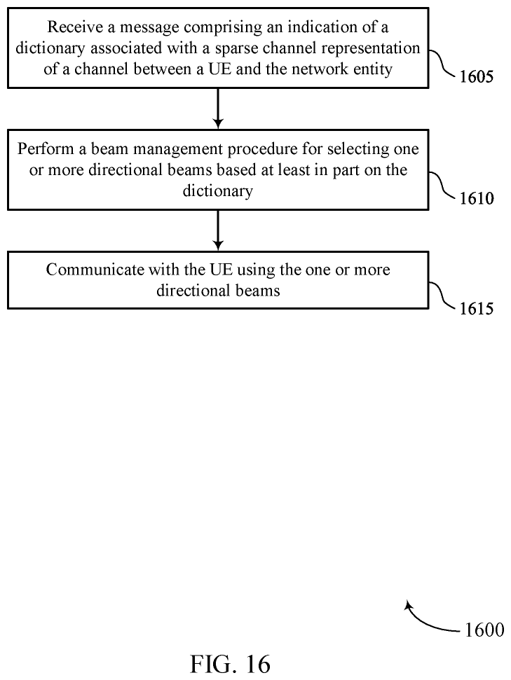

FIG. 16 shows a flowchart illustrating a method 1600 that supports signaling for dictionary learning techniques for channel estimation in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include receiving a message including an indication of a dictionary associated with a sparse channel representation of a channel between a UE and the network entity. The operations of 1605 may be performed in accordance with examples as disclosed herein. In some examples, aspects of the operations of 1605 may be performed by a dictionary reception manager 1225 as described with reference to FIG. 12.

At 1610, the method may include performing a beam management procedure for selecting one or more directional beams based on the dictionary. The operations of 1610 may be performed in accordance with examples as disclosed herein. In some examples, aspects of the operations of 1610 may be performed by a beam management manager 1230 as described with reference to FIG. 12.

At 1615, the method may include communicating with the UE using the one or more directional beams. The operations of 1615 may be performed in accordance with examples as disclosed herein. In some examples, aspects of the operations of 1615 may be performed by a beamforming manager 1235 as described with reference to FIG. 12.

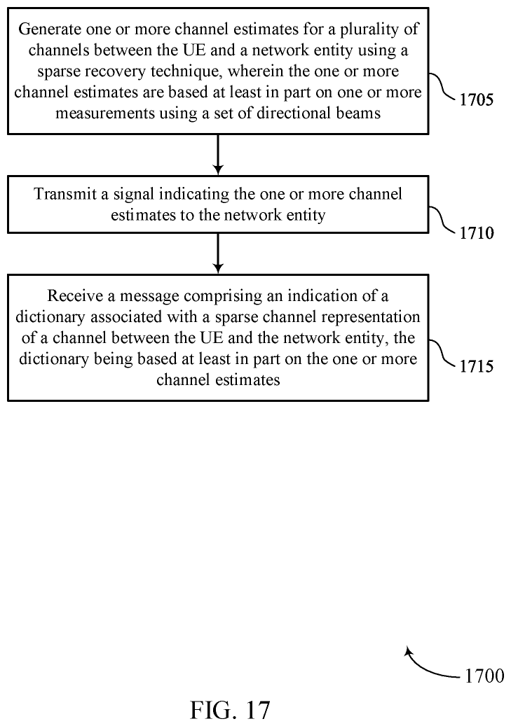

FIG. 17 shows a flowchart illustrating a method 1700 that supports signaling for dictionary learning techniques for channel estimation in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include generating one or more channel estimates for a set of multiple channels between the UE and a network entity using a sparse recovery technique, where the one or more channel estimates are based on one or more measurements using a set of directional beams. The operations of 1705 may be performed in accordance with examples as disclosed herein. In some examples, aspects of the operations of 1705 may be performed by a channel estimate generation component 825 as described with reference to FIG. 8.

At 1710, the method may include transmitting a signal indicating the one or more channel estimates to the network entity. The operations of 1710 may be performed in accordance with examples as disclosed herein. In some examples, aspects of the operations of 1710 may be performed by a channel estimate transmission component 840 as described with reference to FIG. 8.

At 1715, the method may include receiving a message including an indication of a dictionary associated with a sparse channel representation of a channel between the UE and the network entity, the dictionary being based on the one or more channel estimates. The operations of 1715 may be performed in accordance with examples as disclosed herein. In some examples, aspects of the operations of 1715 may be performed by a dictionary indication component 835 as described with reference to FIG. 8.

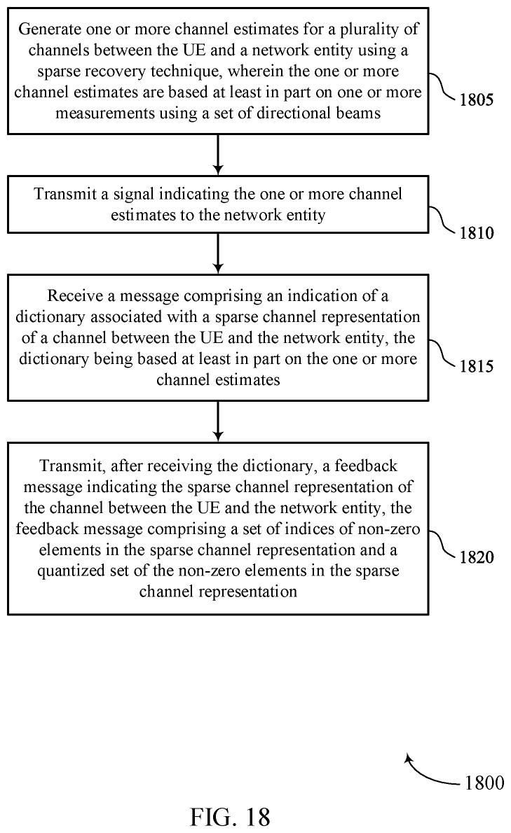

FIG. 18 shows a flowchart illustrating a method 1800 that supports signaling for dictionary learning techniques for channel estimation in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include generating one or more channel estimates for a set of multiple channels between the UE and a network entity using a sparse recovery technique, where the one or more channel estimates are based on one or more measurements using a set of directional beams. The operations of 1805 may be performed in accordance with examples as disclosed herein. In some examples, aspects of the operations of 1805 may be performed by a channel estimate generation component 825 as described with reference to FIG. 8.

At 1810, the method may include transmitting a signal indicating the one or more channel estimates to the network entity. The operations of 1810 may be performed in accordance with examples as disclosed herein. In some examples, aspects of the operations of 1810 may be performed by a channel estimate transmission component 840 as described with reference to FIG. 8.

At 1815, the method may include receiving a message including an indication of a dictionary associated with a sparse channel representation of a channel between the UE and the network entity, the dictionary being based on the one or more channel estimates. The operations of 1815 may be performed in accordance with examples as disclosed herein. In some examples, aspects of the operations of 1815 may be performed by a dictionary indication component 835 as described with reference to FIG. 8.

At 1820, the method may include transmitting, after receiving the dictionary, a feedback message indicating the sparse channel representation of the channel between the UE and the network entity, the feedback message including a set of indices of non-zero elements in the sparse channel representation and a quantized set of the non-zero elements in the sparse channel representation. The operations of 1820 may be performed in accordance with examples as disclosed herein. In some examples, aspects of the operations of 1820 may be performed by a feedback transmission component 845 as described with reference to FIG. 8.

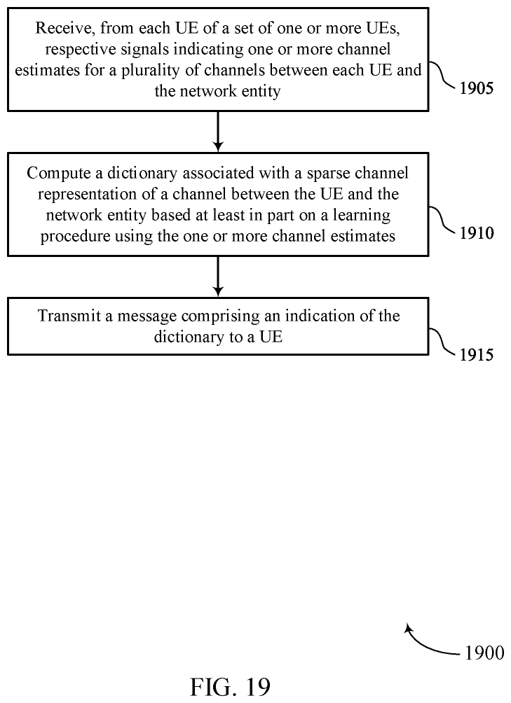

FIG. 19 shows a flowchart illustrating a method 1900 that supports signaling for dictionary learning techniques for channel estimation in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include receiving, from each UE of a set of one or more UEs, respective signals indicating one or more channel estimates for a set of multiple channels between each UE and the network entity. The operations of 1905 may be performed in accordance with examples as disclosed herein. In some examples, aspects of the operations of 1905 may be performed by a channel estimate reception manager 1240 as described with reference to FIG. 12.

At 1910, the method may include computing a dictionary associated with a sparse channel representation of a channel between the UE and the network entity based on a learning procedure using the one or more channel estimates. The operations of 1910 may be performed in accordance with examples as disclosed herein. In some examples, aspects of the operations of 1910 may be performed by a dictionary computation manager 1245 as described with reference to FIG. 12.

At 1915, the method may include transmitting a message including an indication of the dictionary to a UE. The operations of 1915 may be performed in accordance with examples as disclosed herein. In some examples, aspects of the operations of 1915 may be performed by a dictionary indication manager 1250 as described with reference to FIG. 12.

The following provides an overview of aspects of the present disclosure:

Aspect 1: A method for wireless communication at a UE, comprising: generating one or more channel estimates for a plurality of channels between the UE and a network entity using a sparse recovery technique, wherein the one or more channel estimates are based at least in part on one or more measurements using a set of directional beams; computing a dictionary associated with a sparse channel representation of a channel between the UE and the network entity based at least in part on a learning procedure using the one or more channel estimates; and transmitting a message comprising an indication of the dictionary to the network entity.

Aspect 2: The method of aspect 1, further comprising: transmitting a feedback message indicating the sparse channel representation of the channel between the UE and the network entity, the feedback message comprising a set of indices of non-zero elements in the sparse channel representation and a quantized set of the non-zero elements in the sparse channel representation.

Aspect 3: The method of aspect 2, further comprising: receiving a signal indicating a configuration to transmit the sparse channel representation for a number of dominant taps of the channel, wherein transmitting the feedback message is based at least in part on the configuration.

Aspect 4: The method of any of aspects 2 through 3, wherein transmitting the feedback message further comprises: transmitting, with the feedback message, an identifier of the dictionary associated with the sparse channel representation.

Aspect 5: The method of any of aspects 1 through 4, further comprising: receiving a signal indicating a configuration of a threshold number of training samples to obtain prior to computing the dictionary, wherein transmitting the message is based at least in part on the threshold number of training samples being satisfied.

Aspect 6: The method of aspect 5, further comprising: obtaining a number of training samples that at least satisfies the threshold number of training samples, wherein the UE computes the dictionary based at least in part on the number of training samples satisfying the threshold.

Aspect 7: The method of any of aspects 1 through 6, further comprising: obtaining respective training samples at one or more locations of the UE, at one or more times of day, or a combination thereof, wherein the one or more channel estimates are based at least in part on the respective training samples.

Aspect 8: The method of any of aspects 1 through 7, further comprising: receiving a signal indicating a configuration of a set of parameters for computing the dictionary, the set of parameters comprising criteria for stopping the learning procedure, a number of atoms to be included in the dictionary, or a combination thereof, wherein the dictionary is computed in accordance with the set of parameters.

Aspect 9: The method of any of aspects 1 through 8, further comprising: computing an updated dictionary based at least in part on a change in one or more conditions for which the dictionary is dependent, wherein the indication of the dictionary comprises an indication of the updated dictionary.

Aspect 10: The method of aspect 9, wherein the one or more conditions comprise a location of the UE relative to the network entity, a time of day, or a combination thereof.

Aspect 11: The method of any of aspects 1 through 10, wherein generating the one or more channel estimates using the sparse recovery technique further comprises: generating the one or more channel estimates using an orthogonal matching pursuit (OMP) algorithm.

Aspect 12: A method for wireless communication at a network entity, comprising: receiving a message comprising an indication of a dictionary associated with a sparse channel representation of a channel between a UE and the network entity; performing a beam management procedure for selecting one or more directional beams based at least in part on the dictionary; and communicating with the UE using the one or more directional beams.

Aspect 13: The method of aspect 12, further comprising: transmitting, to one or more other UEs, one or more messages each comprising an indication of the dictionary, the one or more other UEs having a same antenna configuration as the UE, being associated with a same manufacturer as the UE, being a same model as the UE, being a same type as the UE, or a combination thereof.

Aspect 14: The method of any of aspects 12 through 13, further comprising: receiving a feedback message indicating the sparse channel representation of the channel between the UE and the network entity, the feedback message comprising a set of indices of non-zero elements in the sparse channel representation and a quantized set of the non-zero elements in the sparse channel representation.

Aspect 15: The method of aspect 14, further comprising: transmitting a signal indicating a configuration for transmitting the sparse channel representation for a number of dominant taps of the channel, wherein receiving the feedback message is based at least in part on the configuration.

Aspect 16: The method of any of aspects 14 through 15, wherein receiving the feedback message further comprises: receiving, with the feedback message, an identifier of the dictionary associated with the sparse channel representation.

Aspect 17: The method of any of aspects 14 through 16, wherein further comprising: estimating the channel between the UE and the network entity using the dictionary and the sparse channel representation, wherein performing the beam management procedure is based at least in part on estimating the channel.

Aspect 18: The method of any of aspects 12 through 17, further comprising: transmitting a signal indicating a configuration of a threshold number of training samples for computing the dictionary, wherein receiving the message is based at least in part on the threshold number of training samples being satisfied.

Aspect 19: The method of any of aspects 12 through 18, further comprising: transmitting a signal indicating a configuration of a set of parameters for computing the dictionary, the set of parameters comprising criteria for stopping a learning procedure, a number of atoms to be included in the dictionary, or a combination thereof, wherein the dictionary is based at least in part on the set of parameters.

Aspect 20: The method of any of aspects 12 through 19, wherein the indication of the dictionary comprises an indication of an updated dictionary that has been updated based at least in part on a change in one or more conditions for which the dictionary is dependent.

Aspect 21: The method of aspect 20, wherein the one or more conditions comprise a location of the UE relative to the network entity, a time of day, or a combination thereof.

Aspect 22: A method for wireless communication at a UE, comprising: generating one or more channel estimates for a plurality of channels between the UE and a network entity using a sparse recovery technique, wherein the one or more channel estimates are based at least in part on one or more measurements using a set of directional beams; transmitting a signal indicating the one or more channel estimates to the network entity; and receiving a message comprising an indication of a dictionary associated with a sparse channel representation of a channel between the UE and the network entity, the dictionary being based at least in part on the one or more channel estimates.

Aspect 23: The method of aspect 22, further comprising: transmitting, after receiving the dictionary, a feedback message indicating the sparse channel representation of the channel between the UE and the network entity, the feedback message comprising a set of indices of non-zero elements in the sparse channel representation and a quantized set of the non-zero elements in the sparse channel representation.

Aspect 24: The method of aspect 23, further comprising: receiving a signal indicating a configuration to transmit the sparse channel representation for a number of dominant taps of the channel, wherein transmitting the feedback message is based at least in part on the configuration.

Aspect 25: The method of any of aspects 23 through 24, wherein transmitting the feedback message further comprises: transmitting, with the feedback message, an identifier of the dictionary associated with the sparse channel representation.

Aspect 26: The method of any of aspects 22 through 25, further comprising: receiving, in the message, an indication of a set of one or more characteristics associated with a set of UEs for which the dictionary is applicable.

Aspect 27: The method of any of aspects 22 through 26, further comprising: receiving, in the message, an indication of set of one or more conditions for which the dictionary is applicable, the set of one or more conditions comprising a geographic location, a time of day, a zone, or a combination thereof.

Aspect 28: The method of any of aspects 22 through 27, further comprising: performing an operation to compress the one or more channel estimates, wherein the signal indicating the one or more channel estimates comprises the compressed one or more channel estimates.

Aspect 29: The method of aspect 28, wherein performing the operation to compress the one or more channel estimates is based at least in part on an auto-encoder, one or more compression schemes, or a combination thereof.

Aspect 30: The method of any of aspects 22 through 29, further comprising: receiving a signal indicating a configuration to transmit the indication of the one or more channel estimates for a number of dominant taps of the channel, wherein transmitting the signal is based at least in part on the configuration.

Aspect 31: The method of any of aspects 22 through 30, further comprising: receiving a second message comprising an indication of a second dictionary associated with a second channel between the UE and the network entity based at least in part on a change in one or more conditions for which the dictionary is dependent.

Aspect 32: The method of aspect 31, wherein the one or more conditions comprise a location of the UE relative to the network entity, a time of day, or a combination thereof.

Aspect 33: The method of any of aspects 22 through 32, further comprising: obtaining respective training samples at one or more locations of the UE, at one or more times of day, or a combination thereof, wherein the one or more channel estimates are based at least in part on the respective training samples.

Aspect 34: The method of any of aspects 22 through 33, wherein generating the one or more channel estimates using the sparse recovery technique further comprises: generating the one or more channel estimates using an orthogonal matching pursuit (OMP) algorithm.

Aspect 35: The method of any of aspects 22 through 34, wherein the message comprises a radio resource control message.

Aspect 36: A method for wireless communication at a network entity, comprising: receiving, from each UE of a set of one or more UEs, respective signals indicating one or more channel estimates for a plurality of channels between each UE and the network entity; computing a dictionary associated with a sparse channel representation of a channel between the UE and the network entity based at least in part on a learning procedure using the one or more channel estimates; and transmitting a message comprising an indication of the dictionary to a UE.

Aspect 37: The method of aspect 36, further comprising: receiving, after transmitting the dictionary, a feedback message indicating the sparse channel representation of the channel between the UE and the network entity, the feedback message comprising a set of indices of non-zero elements in the sparse channel representation and a quantized set of the non-zero elements in the sparse channel representation.

Aspect 38: The method of aspect 37, further comprising: estimating the channel between the UE and the network entity using the dictionary and the sparse channel representation; and performing a beam management procedure for selecting one or more directional beams based at least in part on estimating the channel.

Aspect 39: The method of any of aspects 37 through 38, further comprising: transmitting a signal indicating a configuration for transmitting the sparse channel representation for a number of dominant taps of the channel, wherein receiving the feedback message is based at least in part on the configuration.

Aspect 40: The method of any of aspects 37 through 39, wherein transmitting the feedback message further comprises: receiving, with the feedback message, an identifier of the dictionary associated with the sparse channel representation.

Aspect 41: The method of any of aspects 36 through 40, further comprising: transmitting, in the message, an indication of a set of one or more characteristics associated with a set of UEs for which the dictionary is applicable.

Aspect 42: The method of any of aspects 36 through 41, further comprising: transmitting, in the message, an indication of set of one or more conditions for which the dictionary is applicable, the set of one or more conditions comprising a geographic location, a time of day, a zone, or a combination thereof.

Aspect 43: The method of any of aspects 36 through 42, further comprising: transmitting a signal indicating a configuration for transmitting the one or more channel estimates for a number of dominant taps of the channel, wherein the network entity receives the one or more channel estimates for the number of dominant taps.

Aspect 44: The method of any of aspects 36 through 43, further comprising: transmitting a second message comprising an indication of a second dictionary associated with a second channel between the UE and the network entity based at least in part on a change in one or more conditions for which the dictionary is dependent.

Aspect 45: The method of aspect 44, wherein the one or more conditions comprise a location of the UE relative to the network entity, a time of day, or a combination thereof.

Aspect 46: The method of any of aspects 36 through 45, wherein the respective signals indicating the one or more channel estimates comprises compressed versions of the one or more channel estimates.

Aspect 47: The method of any of aspects 36 through 46, wherein computing the dictionary is based at least in part on each UE of the set of one or more UEs having a same antenna configuration, being associated with a same manufacturer, being a same model, being a same type, or a combination thereof.

Aspect 48: The method of any of aspects 36 through 47, wherein the message comprises a radio resource control message.

Aspect 49: An apparatus for wireless communication at a UE, comprising a processor; memory coupled with the processor; and instructions stored in the memory and executable by the processor to cause the apparatus to perform a method of any of aspects 1 through 11.

Aspect 50: An apparatus for wireless communication at a UE, comprising at least one means for performing a method of any of aspects 1 through 11.

Aspect 51: A non-transitory computer-readable medium storing code for wireless communication at a UE, the code comprising instructions executable by a processor to perform a method of any of aspects 1 through 11.

Aspect 52: An apparatus for wireless communication at a network entity, comprising a processor; memory coupled with the processor; and instructions stored in the memory and executable by the processor to cause the apparatus to perform a method of any of aspects 12 through 21.

Aspect 53: An apparatus for wireless communication at a network entity, comprising at least one means for performing a method of any of aspects 12 through 21.

Aspect 54: A non-transitory computer-readable medium storing code for wireless communication at a network entity, the code comprising instructions executable by a processor to perform a method of any of aspects 12 through 21.

Aspect 55: An apparatus for wireless communication at a UE, comprising a processor; memory coupled with the processor; and instructions stored in the memory and executable by the processor to cause the apparatus to perform a method of any of aspects 22 through 35.

Aspect 56: An apparatus for wireless communication at a UE, comprising at least one means for performing a method of any of aspects 22 through 35.

Aspect 57: A non-transitory computer-readable medium storing code for wireless communication at a UE, the code comprising instructions executable by a processor to perform a method of any of aspects 22 through 35.

Aspect 58: An apparatus for wireless communication at a network entity, comprising a processor; memory coupled with the processor; and instructions stored in the memory and executable by the processor to cause the apparatus to perform a method of any of aspects 36 through 48.

Aspect 59: An apparatus for wireless communication at a network entity, comprising at least one means for performing a method of any of aspects 36 through 48.

Aspect 60: A non-transitory computer-readable medium storing code for wireless communication at a network entity, the code comprising instructions executable by a processor to perform a method of any of aspects 36 through 48.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
generating one or more channel estimates for a plurality of channels between the UE and a network entity using a sparse recovery technique, wherein the one or more channel estimates are based at least in part on one or more measurements using a set of directional beams;
computing a dictionary associated with a sparse channel representation of a channel between the UE and the network entity based at least in part on a learning procedure using the one or more channel estimates; and
transmitting a message comprising an indication of the dictionary to the network entity.

2. The method of claim 1, further comprising:
transmitting a feedback message indicating the sparse channel representation of the channel between the UE and the network entity, the feedback message comprising a set of indices of non-zero elements in the sparse channel representation and a quantized set of the non-zero elements in the sparse channel representation.

3. The method of claim 2, further comprising:
receiving a signal indicating a configuration to transmit the sparse channel representation for a number of dominant taps of the channel, wherein transmitting the feedback message is based at least in part on the configuration.

4. The method of claim 2, wherein transmitting the feedback message further comprises:
transmitting, with the feedback message, an identifier of the dictionary associated with the sparse channel representation.

5. The method of claim 1, further comprising:
receiving a signal indicating a configuration of a threshold number of training samples to obtain prior to computing the dictionary, wherein transmitting the message is based at least in part on the threshold number of training samples being satisfied.

6. The method of claim 5, further comprising:
obtaining a number of training samples that at least satisfies the threshold number of training samples, wherein the UE computes the dictionary based at least in part on the number of training samples satisfying the threshold.

7. The method of claim 1, further comprising:
obtaining respective training samples at one or more locations of the UE, at one or more times of day, or a combination thereof, wherein the one or more channel estimates are based at least in part on the respective training samples.

8. The method of claim 1, further comprising:
receiving a signal indicating a configuration of a set of parameters for computing the dictionary, the set of parameters comprising criteria for stopping the learning procedure, a number of atoms to be included in the dictionary, or a combination thereof, wherein the dictionary is computed in accordance with the set of parameters.

9. The method of claim 1, further comprising:
computing an updated dictionary based at least in part on a change in one or more conditions for which the dictionary is dependent, wherein the indication of the dictionary comprises an indication of the updated dictionary.

10. A method for wireless communication at a network entity, comprising:
receiving a message comprising an indication of a dictionary associated with a sparse channel representation of a channel between a user equipment (UE) and the network entity;
performing a beam management procedure for selecting one or more directional beams based at least in part on the dictionary; and
communicating with the UE using the one or more directional beams.

11. The method of claim 10, further comprising:
transmitting, to one or more other UEs, one or more messages each comprising an indication of the dictionary, the one or more other UEs having a same antenna configuration as the UE, being associated with a same manufacturer as the UE, being a same model as the UE, being a same type as the UE, or a combination thereof.

12. The method of claim 10, further comprising:
receiving a feedback message indicating the sparse channel representation of the channel between the UE and the network entity, the feedback message comprising a set of indices of non-zero elements in the sparse channel representation and a quantized set of the non-zero elements in the sparse channel representation.

13. The method of claim 10, further comprising:
transmitting a signal indicating a configuration of a threshold number of training samples for computing the dictionary, wherein receiving the message is based at least in part on the threshold number of training samples being satisfied.

14. The method of claim 10, further comprising:
transmitting a signal indicating a configuration of a set of parameters for computing the dictionary, the set of parameters comprising criteria for stopping a learning procedure, a number of atoms to be included in the dictionary, or a combination thereof, wherein the dictionary is based at least in part on the set of parameters.

15. A method for wireless communication at a user equipment (UE), comprising:
generating one or more channel estimates for a plurality of channels between the UE and a network entity using a sparse recovery technique, wherein the one or more channel estimates are based at least in part on one or more measurements using a set of directional beams;
transmitting a signal indicating the one or more channel estimates to the network entity; and
receiving a message comprising an indication of a dictionary associated with a sparse channel representation of a channel between the UE and the network entity, the dictionary being based at least in part on the one or more channel estimates.

16. The method of claim 15, further comprising:
transmitting, after receiving the dictionary, a feedback message indicating the sparse channel representation of the channel between the UE and the network entity, the feedback message comprising a set of indices of non-zero elements in the sparse channel representation and a quantized set of the non-zero elements in the sparse channel representation.

17. The method of claim 16, further comprising:
receiving a signal indicating a configuration to transmit the sparse channel representation for a number of dominant taps of the channel, wherein transmitting the feedback message is based at least in part on the configuration.

18. The method of claim 16, wherein transmitting the feedback message further comprises:
transmitting, with the feedback message, an identifier of the dictionary associated with the sparse channel representation.

19. The method of claim 15, further comprising:
receiving, in the message, an indication of a set of one or more characteristics associated with a set of UEs for which the dictionary is applicable.

20. The method of claim 15, further comprising:
receiving, in the message, an indication of set of one or more conditions for which the dictionary is applicable, the set of one or more conditions comprising a geographic location, a time of day, a zone, or a combination thereof.

21. The method of claim 15, further comprising:
performing an operation to compress the one or more channel estimates, wherein the signal indicating the one or more channel estimates comprises the compressed one or more channel estimates.

22. The method of claim 15, further comprising:
receiving a signal indicating a configuration to transmit the indication of the one or more channel estimates for a number of dominant taps of the channel, wherein transmitting the signal is based at least in part on the configuration.

23. The method of claim 15, further comprising:
receiving a second message comprising an indication of a second dictionary associated with a second channel between the UE and the network entity based at least in part on a change in one or more conditions for which the dictionary is dependent.

24. The method of claim 15, further comprising:
obtaining respective training samples at one or more locations of the UE, at one or more times of day, or a combination thereof, wherein the one or more channel estimates are based at least in part on the respective training samples.

25. A method for wireless communication at a network entity, comprising:
receiving, from each user equipment (UE) of a set of one or more UEs, respective signals indicating one or more channel estimates for a plurality of channels between each UE and the network entity;
computing a dictionary associated with a sparse channel representation of a channel between the UE and the network entity based at least in part on a learning procedure using the one or more channel estimates; and
transmitting a message comprising an indication of the dictionary to a UE.

26. The method of claim 25, further comprising:
receiving, after transmitting the dictionary, a feedback message indicating the sparse channel representation of the channel between the UE and the network entity, the feedback message comprising a set of indices of non-zero elements in the sparse channel representation and a quantized set of the non-zero elements in the sparse channel representation.

27. The method of claim 25, further comprising:
transmitting, in the message, an indication of a set of one or more characteristics associated with a set of UEs for which the dictionary is applicable.

28. The method of claim 25, further comprising:
transmitting, in the message, an indication of set of one or more conditions for which the dictionary is applicable, the set of one or more conditions comprising a geographic location, a time of day, a zone, or a combination thereof.

29. The method of claim 25, further comprising:
transmitting a signal indicating a configuration for transmitting the one or more channel estimates for a number of dominant taps of the channel, wherein the network entity receives the one or more channel estimates for the number of dominant taps.

30. The method of claim 25, further comprising:
transmitting a second message comprising an indication of a second dictionary associated with a second channel between the UE and the network entity based at least in part on a change in one or more conditions for which the dictionary is dependent.
